(19) United States
(12) Patent Application Publication
(10) Pub. No.: US 2015/0213706 A1
(43) Pub. Date: Jul. 30, 2015

(54) FACILITY STATUS MONITORING METHOD AND FACILITY STATUS MONITORING DEVICE

(71) Applicant: Hitachi, Ltd., Tokyo (JP)

(72) Inventors: Jie Bai, Tokyo (JP); Hisae Shibuya, Tokyo (JP); Shunji Maeda, Tokyo (JP)

(73) Assignee: Hitachi, Ltd., Tokyo (JP)

(21) Appl. No.: 14/416,466

(22) PCT Filed: Jul. 5, 2013
(86) PCT No.: PCT/JP2013/068531

§ 371 Date: Jan. 22, 2015

(30) Foreign Application Priority Data
Aug. 29, 2012 (JP) 2012-188649

(51) Int. Cl. G08B 21/18

(52) U.S. Cl. CPC G08B 21/185; G08B 21/182

(57) ABSTRACT

In a facility such as a plant, error detection can be performed by using characteristic amounts based on a statistical probability characteristic, but when sensor data is acquired at long sampling intervals for reducing costs, those intense changes cannot always be caught. Furthermore, when the sensor sampling time is not synchronized with the start of a sequence, a time difference occurs between sensor data obtained in the same sequence at different times, so it is not possible to determine a statistical probability characteristic for areas of intense change. Therefore, with the present invention a statistical probability characteristic for a time period to be monitored is calculated by estimating the sensor data that cannot be obtained, and error detection is performed on the basis of that statistical probability characteristic with respect to sequences with intense changes. Thus, it is possible to perform error detection with respect to sequences with intense changes.

### BACKGROUND

The present invention relates to a facility status monitoring method and facility status monitoring device that sense in an early stage a malfunction of a facility or a sign of the malfunction, which occurs during an ever-changing activation or suspension sequence, on the basis of multidimensional time-sequential data items outputted from a plant or facility, or restore a continual change, which cannot be obtained because of a sampling interval that is made longer for the purpose of reducing a cost, and monitor statistical-probability properties of the change.

Electric power companies supply warm water for district heating by utilizing waste heat of a gas turbine or the like, or supply high-pressure steam or low-pressure steam to factories. Petrochemical companies run the gas turbine or the like as a power supply facility. At various plants or facilities employing the gas turbine or the like, preventive maintenance for sensing a malfunction of a facility or a sign of the malfunction has quite significant meanings even from the viewpoint of minimizing damage to a society. In particular, a failure is liable to occur frequently during an ever-changing sequence such as activation or suspension. Therefore, it is important to sense in an early stage an abnormality occurring during the period.

Not only a gas turbine or steam turbine but also a water wheel at a hydroelectric power plant, a reactor at a nuclear power plant, a windmill at a wind power plant, an engine of an aircraft or heavy machinery, a railroad vehicle or track, an escalator, an elevator, and machining equipment for cutting or boring are requested to immediately sense an abnormality in the performance for the purpose of preventing occurrence of a fault in case such an abnormality is found.

Accordingly, plural sensors are attached to a facility or plant concerned in order to automatically decide based on a monitoring criterion set for each of the sensors whether the facility or plant is normal or abnormal. An example proved effective in sensing an abnormality during normal running of such an object as a facility, manufacturing equipment, or measuring equipment has been disclosed in Patent Literature 1 (Japanese Patent Application Laid-Open No. 2011-070635). In the disclosed example of Patent Literature 1, multidimensional data items of a facility are mapped into a feature space, and a normal model is created in the feature space. A projection distance of newly inputted sensor data to the normal model is regarded as an abnormality measure. An abnormality is sensed based on whether the abnormality measure exceeds a predetermined threshold.

As a typical technique of sensing an abnormality while calculating parameters that represent statistical-probability properties and enable simultaneous monitoring of the statistical-probability properties of time-sequential sensor data items, a method is disclosed in Non-Patent Literature 1 and Non-Patent Literature 2. According to the method, statistical-probability parameters calculated directly from a sensor wave at respective times are used to produce a normal model. An abnormality is sensed using a degree of separation from the model.

### CITATION LIST

### Patent Literature

PTL 1: Japanese Patent Application Laid-Open No. 2011-070635

### Non Patent Literature

Non Patent Literature 1: “Discussion on sensing of an abnormality of a power generator based on a sensor model and voting” (collection of lectures and papers of the Forum on Information Technology 8(3), 139-142, 2009)
Non Patent Literature 2: “Abnormality detection based on a likelihood histogram” (Technical Committee on Pattern Recognition and Media Understanding (PRMU), 2011)

### SUMMARY

The technology disclosed in Patent Literature 1 has difficulty in presaging or sensing an abnormality occurring during an ever-changing activation or suspension sequence or in machining equipment whose load varies greatly. FIG. 12 shows a change in a local space in a feature space derived from a difference in a running mode which is clarified according to the method described in Patent Literature 1. As seen from the drawing, at a steady running time in (a), values of acquired normal sensor data items are nearly on a level with one another. In the feature space, a normal local space created based on the normal sensor data items is small. When an abnormality occurs, abnormal data is largely separated from the normal local space and is readily recognizable.

In contrast, in the case of an ever-changing sequence, for example, an activation sequence in (b), a change in a data value of acquired normal sensor data items is so large that a normal local space in the feature space created from the normal sensor data items is spread more widely than that obtained at the time of steady running. If an abnormality occurs during the sequence period, abnormal data is found in the normal local space in the feature space, and is hard to be sensed as an abnormality.

According to the method disclosed in the Non-Patent literature 1 and Non-Patent Literature 2, a degree of abnormality is calculated at each time. Therefore, when a sequence changes continually, an abnormality occurring during the sequence can be sensed. However, at a facility such as a plant, if sensor data items are merely acquired in units of a long sampling interval because of a reduction in cost, the continual change cannot be fully grasped. If sampling times of a sensor are not synchronous with the initiation of the sequence, a time lag arises between sensor data items acquired at different times during the same sequence. If data items cannot be acquired with multidimensional sensors synchronized with each other, the time lag arises between sensor data items of the sensors. Therefore, the technology disclosed in Non-Patent Literature 1 and Non-Patent Literature 2 cannot calculate a statistical-probability parameter at each time, and cannot therefore sense an abnormality.

The present invention solves the foregoing problems of the related arts, and provides a facility status monitoring method and facility status monitoring device employing an abnormality sensing method capable of sensing an abnormality while monitoring a continual change in an ever-changing activation or suspension sequence and statistical-probability properties of the change.

In order to solve the aforesaid problems, the present invention provides a method of sensing an abnormality of a plant or facility in which: a sensor signal intermittently outputted from a sensor attached to a plant or facility, and event signals associated with the initiation and termination respectively of an activation sequence or suspension sequence of the plant or facility during the same period as a period during which the sensor signal is acquired are inputted; a sensor signal associated with a section between the event signal of the initiation of the activation sequence or suspension sequence and the event signal of the termination thereof is cut from the inputted sensor signal; signal values at certain times of the cut sensor signal and probability distributions thereof are estimated; a feature quantity is extracted based on the estimated probability distributions; and an abnormality of the plant or facility is sensed based on the extracted feature quantity.

In order to solve the aforesaid problems, the present invention provides a device that senses an abnormality of a plant or facility, and that includes: a data preprocessing unit that inputs a sensor signal, which is intermittently outputted from a sensor attached to the plant or facility, and event signals associated with the initiation and termination respectively of an activation sequence or suspension sequence of the plant or facility during the same period as a period during which the sensor signal is outputted, cuts a sensor signal, which is associated with a section between the event signal of the initiation of the activation sequence or suspension sequence and the event signal of the termination thereof, from the inputted sensor signal, and synchronizes the cut sensor signal with times that are obtained with the event signal of the initiation of the activation sequence or suspension sequence as an origin; a probability distribution estimation unit that estimates signal values at certain times of the sensor signal, which is processed by the data preprocessing unit, and probability distributions thereof; a feature quantity extraction unit that extracts a feature quantity on the basis of the probability distributions estimated by the probability distribution estimation unit; an abnormality detector that detects an abnormality of the plant or facility on the basis of the feature quantity extracted by the feature quantity extraction unit; and an input/output unit that has a screen on which information to be inputted or outputted is displayed, and displays on the screen information concerning the abnormality of the plant or facility detected by the abnormality detector.

According to the present invention, sensor data items that cannot be acquired due to a restriction, which is imposed on equipment, in an ever-changing scene are densely estimated in order to grasp an abnormality occurring in the scene. Therefore, an abnormality occurring during an ever-changing sequence can be sensed.

According to the present invention, sensor data items that cannot be acquired are estimated. Therefore, a time lag between sensor data items acquired at different times during the same sequence, which occurs because sampling times of a sensor are not synchronous with the initiation of the sequence, can be resolved. In addition, a time lag between sensor data items of different sensors which occurs because the data items are not acquired with multidimensional sensors synchronized with each other can be resolved. Accordingly, a statistical-probability property of a sensor wave at an arbitrary time during the sequence period can be monitored.

Accordingly, a system capable of both highly sensitively sensing and easily explaining an abnormality of any of various facilities and components, which include not only a facility such as a gas turbine or steam turbine but also a water wheel at a hydroelectric power plant, a reactor at a nuclear power plant, a windmill at a wind power plant, an engine of an aircraft or heavy equipment, a railroad vehicle or track, an escalator, and an elevator, and deterioration or a service life of a battery incorporated in equipment or a component can be realized.

### BRIEF DESCRIPTION OF THE DRAWINGS

FIG. 1A is a block diagram showing an outline configuration of a facility status monitoring system of the present invention;

FIG. 1B is a flowchart (single class) describing a flow of processing for learning;

FIG. 1C is a flowchart (multi-class) describing the flow of processing for learning;

FIG. 1D is a flowchart describing a flow of processing for abnormality sensing;

FIG. 1E is a flowchart describing a flow of sensor data estimation time determination processing;

FIG. 2A is a diagram showing images of sensor waves each having an initiation time and termination time indicated thereon;

FIG. 2B is a flowchart describing a flow of determination processing for sensor data cutting initiation and termination times;

FIG. 2C is a diagram showing an index for use in determining the sensor data cutting initiation or termination time;

FIG. 3A is a diagram showing an example of event data items;

FIG. 3B is a diagram showing the imagery of processing of receiving event data and adjusting times;

FIG. 3C is a diagram showing the imagery of another processing of receiving event data and adjusting times;

FIG. 4 is a flowchart describing a flow of processing to be performed by a sensor data estimation time determination unit;

FIG. 5A is an explanatory diagram of sensor data estimation processing;

FIG. 5B is an explanatory diagram of another sensor data estimation processing;

FIG. 5C is an explanatory diagram of correction processing at a sampling point;

FIG. 6A is an explanatory diagram of probability distribution estimation processing;

FIG. 6B is an explanatory diagram of another probability distribution estimation processing;

FIG. 7A is a flowchart describing a flow of feature quantity extraction processing;

FIG. 7B is a diagram showing feature quantities;

FIG. 8A is a flowchart describing a flow of sensor data convergence discrimination processing;

FIG. 8B is a diagram showing a sensor data convergence discrimination index (converging on a certain value);

FIG. 8C is a diagram showing the sensor data convergence discrimination index (oscillating with the certain value as a center);

FIG. 9A is a diagram showing a graphical user interface (GUI) that displays an outcome of abnormality sensing (two-dimensional display);

FIG. 9B is a diagram showing the GUI that displays the outcome of abnormality sensing (three-dimensional display);

FIG. 10 is a diagram showing a GUI for use in designating sequence cutting, a sensor data estimation technique, and others;

FIG. 11A is a diagram showing a GUI for use in checking pre- and post-sensor data estimation measurement curves;

FIG. 11B is a diagram showing a GUI for use in checking the post-sensor data estimation curve, a sensor model, and a statistical probability distribution; and

FIG. 12 is a diagram showing a change in a local space in a feature space derived from a difference in a running mode.

### DESCRIPTION OF THE PREFERRED EMBODIMENTS

The present invention relates to a facility status monitoring method and facility status monitoring device that sense a malfunction of a facility or a sign of the malfunction occurring when a sequence for an ever-changing activation or suspension is implemented at the facility such as a plant. Herein, times are adjusted with respect to the initiation time of the sequence, estimation times for sensor data items to be intermittently outputted are determined, and sensor data items to be observed at the times are estimated. Thus, an abnormality is sensed based on probability distributions obtained at the respective times in consideration of a time-sequential transition.

An example of the present invention will be described below in conjunction with the drawings.

### Example 1

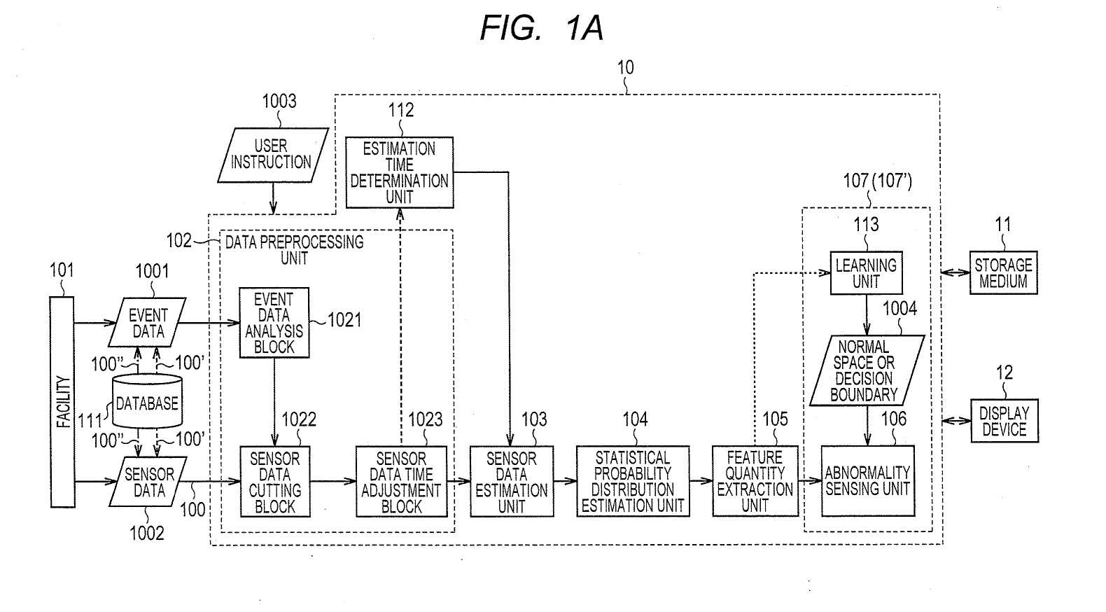

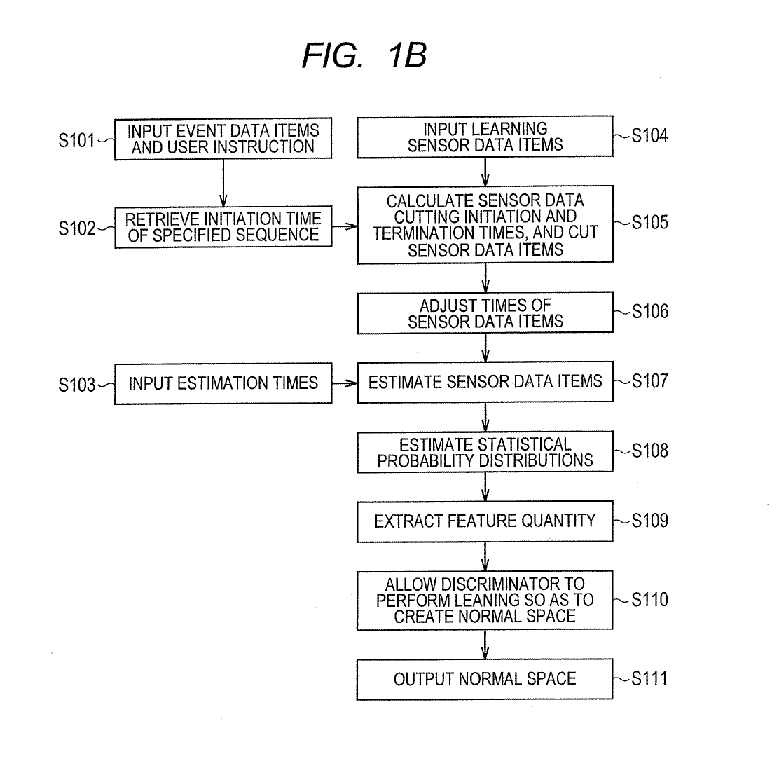

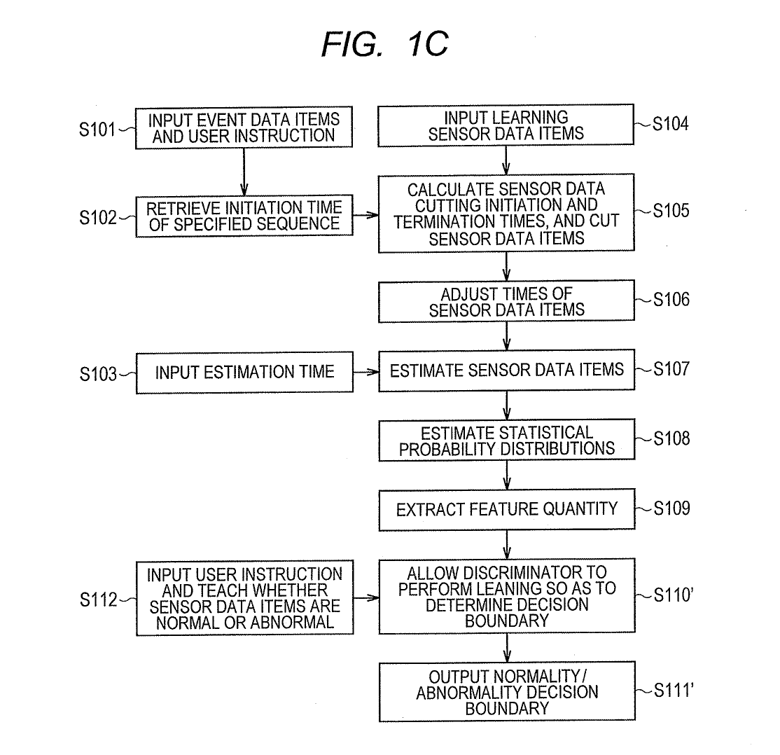

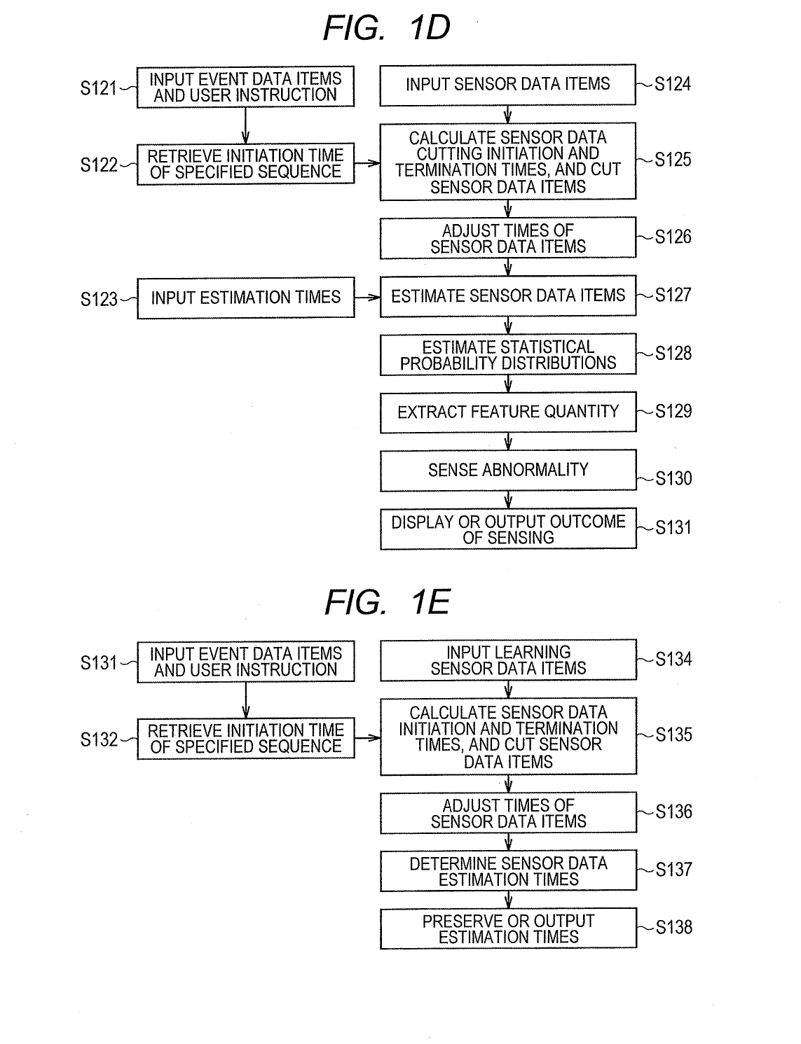

FIG. 1A shows an example of a configuration of a system that realizes a facility status monitoring method of the present example.

The system includes an abnormality sensing system 10 that senses an abnormality on receipt of sampling sensor data items 1002 and event data items 1001, which are outputted from a facility 101 or database 111, and a user instruction 1003 entered by a user, a storage medium 11 in which a halfway outcome or an outcome of abnormal sensing is stored, and a display device 12 on which the halfway outcome or the outcome of abnormal sensing is displayed.

The abnormal sensing system 10 includes a data preprocessing unit 102 that processes data, an estimation time determination unit 112 that determines sensor data estimation times after the data preprocessing unit 102 processes sensor data items 1002 and event data items 1001 fed from the database 111, a sensor data estimation unit 103 that estimates sensor data items to be observed at the times determined by the sensor data estimation time determination unit 112 after the data preprocessing unit 102 processes sensor data items 1002 and event data items 1001 fed from the facility 101, a statistical probability distribution estimation unit 104 that estimates statistical probability distributions to be obtained at the times, a feature quantity extraction unit 105 that extracts a feature quantity using the statistical probability distributions, a learning unit 113 that performs learning using the feature quantity extracted by the feature quantity extraction unit 105, and an abnormality sensing unit 106 that senses an abnormality using a normal space or decision boundary 1004 outputted from the learning unit 113 after completion of learning.

Further, the data preprocessing unit 102 includes an event data analysis block 1021 that retrieves an initiation time of a user-specified sequence from among event data items 1001, a sensor data cutting block 1022 that calculates initiation and termination times, which are used to cut sensor sampling data items from among sensor data items 1002 received using information on the initiation time of the specified sequence, and cuts sensor data items 1002, and a sensor data time adjustment block 1023 that adjusts the times of the cut sensor data items.

The learning unit 113, decision boundary 1004, and abnormality sensing unit 106 constitute a discriminator 107 (107′).

Actions of the present system fall into three phases, that is, an estimation time determination phase in which sensor data estimation times are determined using data items accumulated in the database 111, a learning phase in which the normal space or decision boundary 1004 to be employed in abnormality sensing is determined using the accumulated data items, and an abnormality sensing phase in which abnormality sensing is actually performed based on the normal space or decision boundary using the sensor data items inputted after being corrected at estimation times. Fundamentally, the two phases of the estimation time determination phase and learning phase are pieces of offline processing, while the third phase of the abnormality sensing phase is online processing. However, abnormality sensing may be performed as offline processing. Hereinafter, these phases may be distinguished from one another by mentioning merely estimation time determination, learning, and abnormality sensing respectively.

A solid-line arrow 100 in FIG. 1A indicates an abnormality sensing path implying a flow of data in the abnormality sensing phase. Dotted-line arrows 100′ indicate learning paths implying flows of data in the learning phase. Dashed-line arrows 100″ indicate estimation time determination paths implying flows of data in the estimation time determination phases.

The facility 101 that is an object of state monitoring is a facility or plant such as a gas turbine or steam turbine. The facility 101 outputs sensor data 1002 representing the state and event data 1001.

In the present example, processing of the estimation time determination phase is first performed offline, and processing of the learning phase is thereafter performed offline using an outcome of the processing of the estimation time determination phase. Thereafter, the online processing of the abnormality sensing phase is performed using the outcome of the processing of the estimation time determination phase and an outcome of the learning phase.

Sensor data items 1002 are multidimensional time-sequential data items acquired from each of plural sensors, which are attached to the facility 101, at regular intervals. The number of sensors may range from several hundreds of sensors to several thousands of sensors which depends on the size of the facility or plant. The type of sensors may include, for example, a type of sensing the temperature of a cylinder, oil, or cooling water, a type of sensing the pressure of the oil or cooling water, a type of sensing the rotating speed of a shaft, a type of sensing a room temperature, and a type of sensing a running time. The sensor data may not only represent an output or state but also be control data with which something is controlled to attain a certain value.

A flow of processing for estimation time determination will be described below in conjunction with FIG. 1E. The processing is performed using event data items 1001 and sensor data items 1002 extracted from the database 111 along the estimation time determination paths 100″.

More particularly, the event data analysis block 1021 of the data preprocessing unit 102 inputs the event data items 1001 outputted from the database 111 and the user instruction 1003 (S131), and retrieves the initiation time of a sequence, which is specified with the user instruction 1003, from among the inputted event data items 1001 (S132). The sensor data cutting block 1022 inputs the sensor data items 1002 outputted from the database 111 (S134), calculates the sensor data cutting initiation time, which is associated with the sequence initiation time obtained by the event data analysis block 1021, and the sensor data cutting termination time, and cuts sensor data items from among the sensor data items 1002 inputted from the database 111 (S135).

Thereafter, the cut sensor data items are sent to the sensor data time adjustment block 1023, have the times thereof adjusted by the sensor data time adjustment block 1023 (S136), and are sent to the estimation time determination unit 112 in order to determine sensor data estimation times (S137). The determined estimation times are preserved or outputted (S138).

A flow of processing for learning will be described below in conjunction with FIG. 1B and FIG. 1C. The processing is performed using event data items 1001 and sensor data items 1002 extracted from the database 111 along the estimation time determination paths 100′.

FIG. 1B describes learning to be performed using a single-class discriminator 107, while FIG. 1C describes learning to be performed using a multi-class discriminator 107′.

In FIG. 1B or FIG. 1C, first, the event data analysis block 1021 inputs the event data items 1001 outputted from the database 111 and the user instruction 1003 (S101), retrieves the initiation time of a sequence, which is specified with the user instruction 1003, from among the inputted event data items 1001 (S102).

The sensor data cutting block 1022 inputs the sensor data items 1002 outputted from the database 111 (S104), calculates the sensor data cutting initiation time, which is associated with the sequence initiation time obtained by the event data analysis block 1021, and the sensor data cutting termination time, and cuts sensor data items from among the sensor data items 1002 inputted from the database 111 (S105). The sensor data time adjustment block 1023 adjusts the times of the cut sensor data items (S106).

Thereafter, learning is performed using sensor data items that have times thereof adjusted. The sensor data estimation times outputted from the estimation time determination unit 112 are inputted to the sensor data estimation unit 103 (S103). Based on the information on the inputted sensor data estimation times, the sensor data estimation unit 103 estimates the times of sensor data items (S107). Thereafter, the statistical probability distribution estimation unit 104 estimates statistical probability distributions of the sensor data items having the times thereof estimated (S108). Based on the estimated statistical probability distributions, the feature quantity extraction unit 105 extracts the feature quantity of the estimated sensor data items (S109).

Finally, when the single-class discriminator 107 is employed as described in FIG. 1B, the learning unit 113 of the discriminator 107 performs learning using the feature quantity of the sensor data items extracted by the feature quantity extraction unit 105 so as to create a normal space (S110). The created normal space is outputted (S111).

In contrast, when the multi-class discriminator 107′ is employed as described in FIG. 1C, a file containing indices signifying that respective sensor data items read from the database 111 are normal or abnormal is inputted in response to the user instruction 1003, and whether the sensor data items are normal or abnormal is taught (S112). Thereafter, the learning unit 113 of the discriminator 107′ performs learning using the feature quantity extracted by the feature quantity extraction unit 105, and determines the decision boundary 1004 for use in discriminating normality or abnormality (S110′). The determined decision boundary 1004 is outputted (S111′).

Next, a flow of processing for abnormality sensing to be performed on newly observed sensor data items will be described below in conjunction with FIG. 1D. The processing is performed using event data items 1001 and sensor data items 1002 extracted from the facility 101 along the abnormality sensing path 100. To begin with, the event data analysis block 1021 inputs the event data items 1001 outputted from the facility 101 and the user instruction 1003 (S121), and retrieves the initiation time of a user-specified sequence (S122).

The sensor data cutting block 1022 inputs the sensor data items 1002 outputted from the facility 101 (S124), calculates the sensor data cutting initiation time, which is associated with the sequence initiation time obtained by the event data analysis block 1021, and the sensor data cutting termination time, and cuts sensor data items (S125). The sensor data time adjustment block 1023 adjusts the times of the cut sensor data items (S126).

Thereafter, the sensor data estimation times determined and preserved in advance by the estimation time determination unit 112 during learning are inputted into the sensor data estimation unit 103 (S123). The sensor data estimation unit 103 estimates sensor data items at the sensor data estimation times, which are inputted from the estimation time determination unit 112, in relation to the sensor data items that have the times thereof adjusted and are inputted from the sensor data time adjustment block 1023 (S127). The statistical probability distribution estimation unit 104 estimates the statistical probability distributions of the estimated sensor data items (S128), and the feature quantity extraction unit 105 extracts a feature quantity on the basis of the estimated statistical probability distributions (S129).

Finally, using the feature quantity extracted by the feature quantity extraction unit 105, and the normal space or decision boundary 1004 created by the learning unit 113 of the discriminator 107 (107′), the abnormality sensing unit 106 performs abnormality discrimination (S130), and outputs or displays an outcome of sensing (S131).

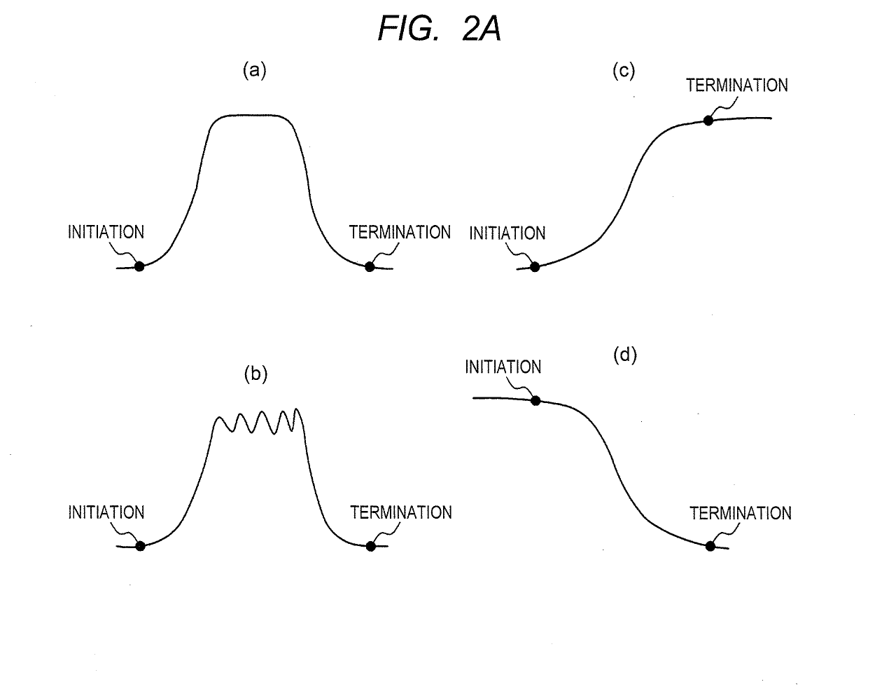

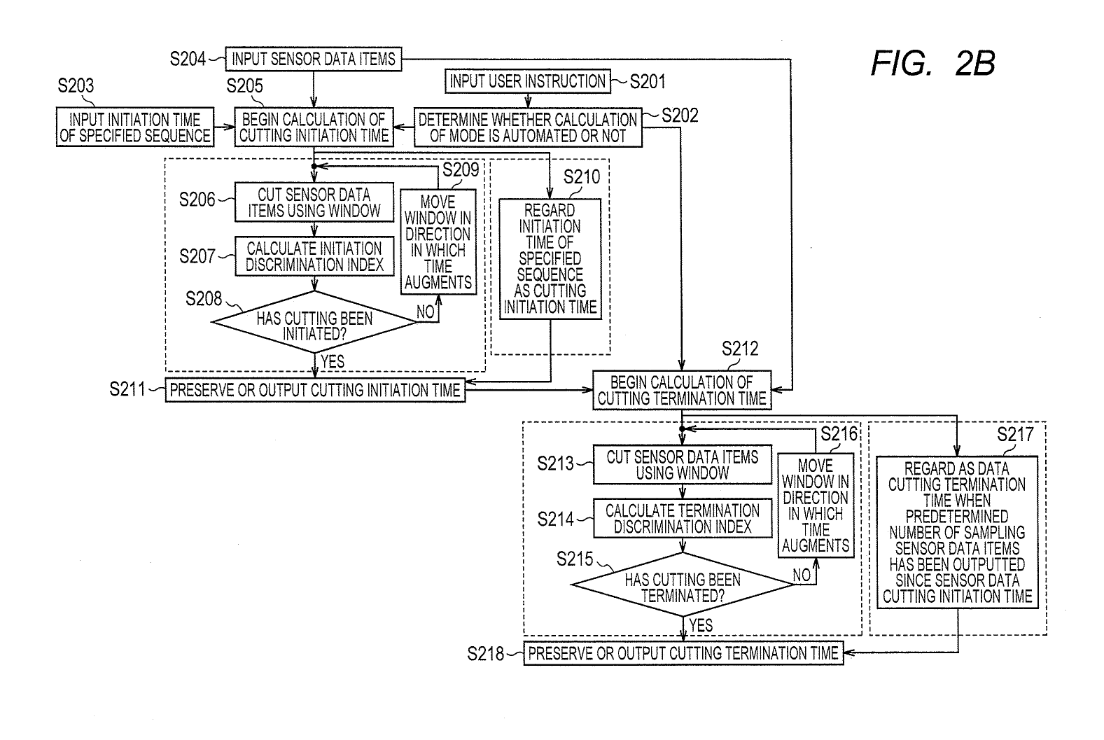

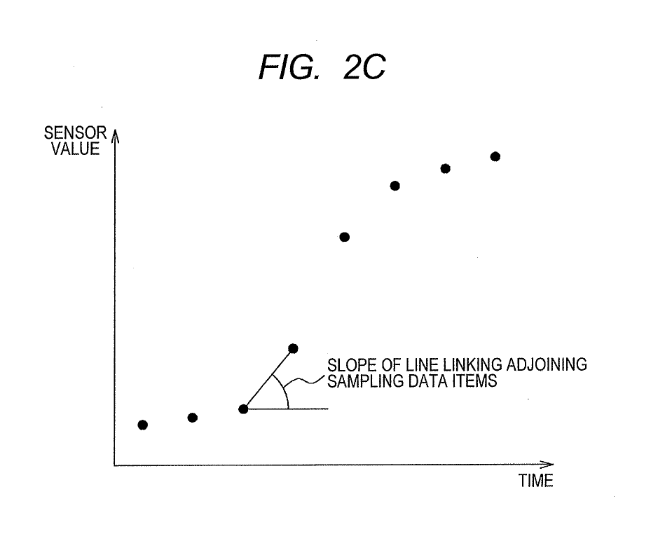

Next, actions of the components mentioned in FIG. 1A will be sequentially described below. That is, determination of cutting initiation and termination times in the sensor data cutting block 1022, adjustment of sensor data times in the sensor data time adjustment block 1023, determination of sensor data estimation times in the estimation time determination unit 112, estimation of sensor data items in the sensor data estimation unit 103, estimation of probability distributions in the statistical probability distribution estimation unit 104, and extraction of a feature quantity in the feature quantity extraction unit 105 will be described below in conjunction with FIG. 2A to FIG. 8C.

[Determination of Cutting Initiation and Termination Times]

In the sensor data cutting block 1022, first, sensor data cutting initiation and termination times are calculated. Then, sensor data items observed between the times are cut by using the cutting initiation and termination times.

FIG. 2A is a diagram showing images of sensor waves having cutting initiation and termination times marked thereon. Examples (a) and (b) in FIG. 2A include both a rising edge and falling edge of a sensor wave during a period from when cutting is initiated to when the cutting is terminated. Sensor data values at the initiation and termination times respectively are on a level with each other. In the example (a), the sensor wave smoothly varies between the rising edge and falling edge. In the example (b), the wave zigzags between the rising edge and falling edge. In an example (c) in which an activation sequence alone is observed, and the example (d) in which a suspension sequence alone is observed, the sensor data values at the cutting initiation and termination times respectively have different levels.

Next, a flow of processing of calculating cutting initiation and termination times for the purpose of cutting sensor data items, and cutting initiation and termination discrimination indices will be described below in conjunction with FIG. 2B and FIG. 2C.

FIG. 2B is a diagram showing a flow of sensor data cutting initiation and termination discrimination. The sensor data cutting block 1022 first inputs the user instruction 1003 (S201), and determines based on the user instruction whether calculation of a mode (initiation or termination) is automated or not automated (S202). Thereafter, the sensor data cutting block 1022 inputs the initiation time of a specified sequence obtained by the event data analysis block 1021 (S203), and inputs the sensor data items 1002 outputted from the facility 101 or database 111 (S204). On receipt of the initiation time of the specified sequence obtained at S203, the sensor data items obtained at S204, and the outcome of determination on whether the initiation mode is automated or not automated which is obtained at S202, calculation of the cutting initiation time is begun (S205).

In a case where calculation of a cutting initiation time is automated, a window is used to cut partial sensor data items (S206), an initiation discrimination index is calculated (S207), and initiation is discriminated (S208). If a No decision is made, the window is moved in a direction in which the time augments (S209), and initiation discrimination (S206 to S208) is repeated. If a Yes decision is made, the sensor data cutting initiation time is outputted or preserved (S211).

In contrast, if automatic calculation is not performed, the initiation time of a specified sequence is regarded as a sensor data cutting initiation time (S210), and the sensor data cutting initiation time is outputted (S211).

After the sensor data cutting initiation time is calculated, calculation of a sensor data cutting termination time is performed. The calculation of the sensor data cutting termination time is begun on receipt of the cutting initiation time obtained at S211 and the outcome of determination on whether a termination mode is automated or not automated which is obtained at S202 (S212).

If the calculation of the cutting termination time is automatically performed, sensor data items having been observed since the cutting initiation time are concerned, and part of the sensor data items is cut using a window (S213). A termination discrimination index is calculated (S214), and termination discrimination is performed (S215). If a No decision is made, the window is moved in a direction in which the time augments (S216), and termination discrimination (S213 to S215) is repeated. If a Yes decision is made, the sensor data cutting termination time is outputted or preserved (S218).

If automatic calculation is not performed, a time when a predetermined number of sensor data items has been observed since the sensor data cutting initiation time is regarded as a sensor data cutting termination time (S217), and the sensor data cutting termination time is outputted (S218).

FIG. 2C shows an example of initiation and termination discrimination indices. In this example, two adjoining sensor data items are linked with a straight line, and the slope of the straight line is regarded as the initiation or termination discrimination index. A time when the index gets larger than a predetermined threshold is regarded as the sensor data cutting initiation time. A time when the index gets smaller than the predetermined threshold is regarded as the sensor data cutting termination time.

[Adjustment of Times of Sensor Data Items]

Processing in the sensor data time adjustment block 1023 is performed using the cutting initiation time obtained by the sensor data cutting block 1022.

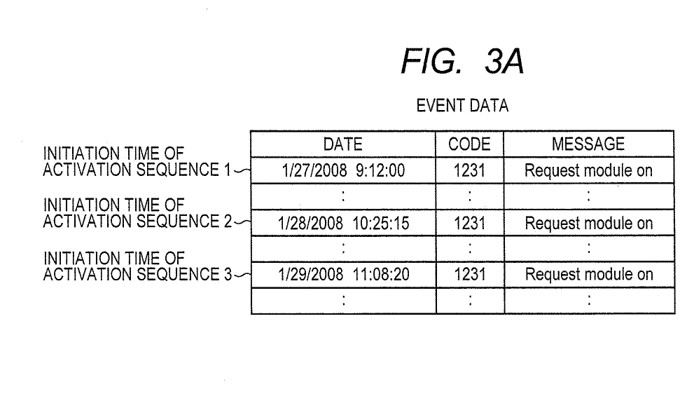

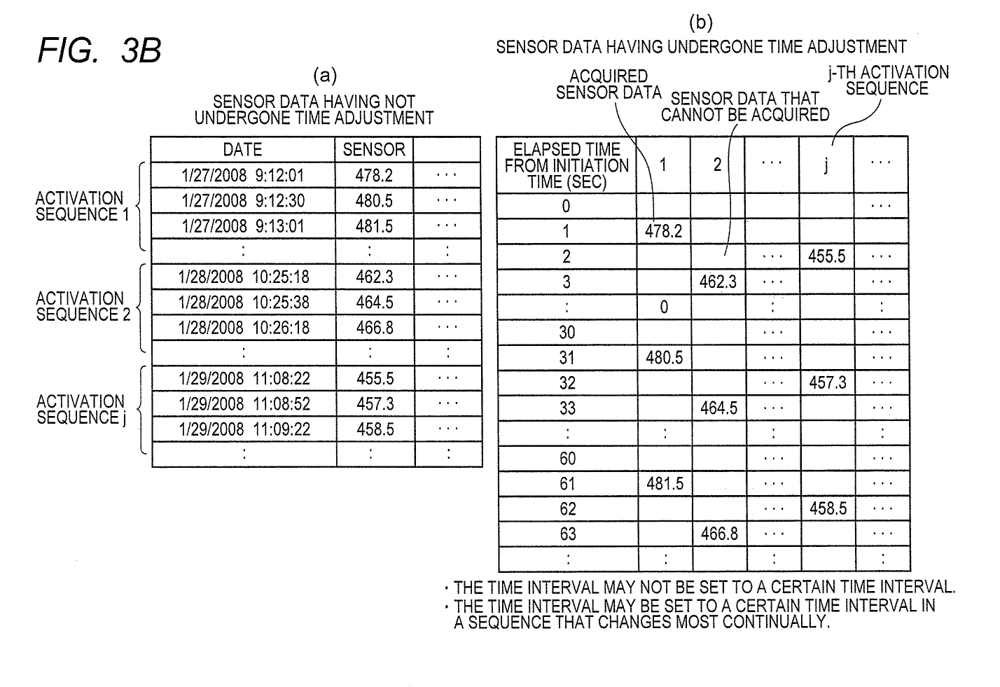

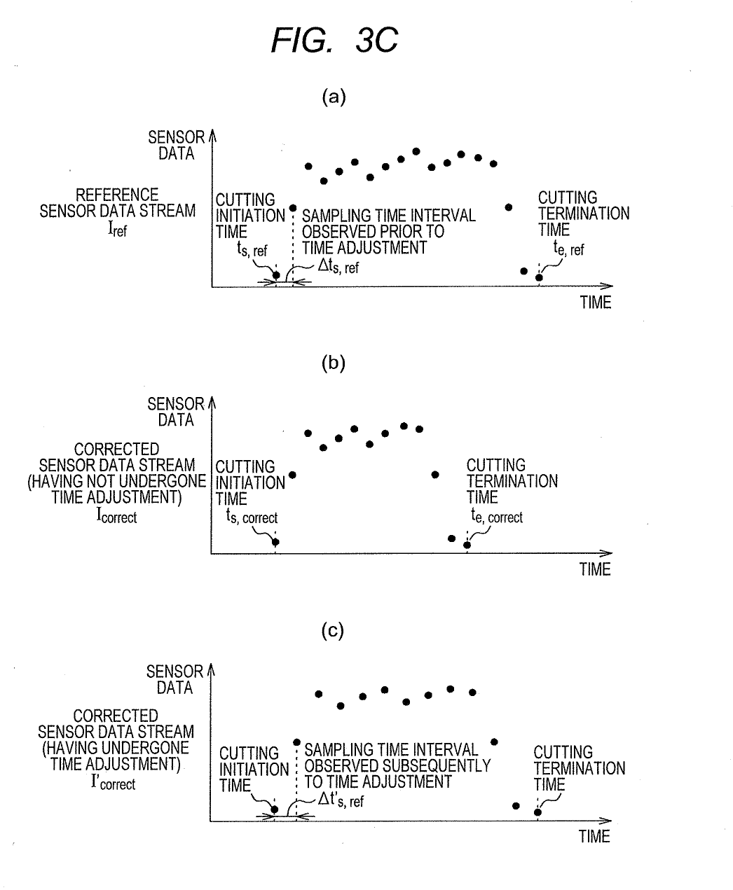

FIG. 3A shows an example of event data items 1001. The event data 1001 is a signal representing an operation, failure, or warning concerning a facility which is outputted irregularly, and including a time, a unique code which represents the operation, failure, or warning, and a message character string. For example, the character string associated with the initiation of an activation sequence or the initiation of a suspension sequence is “Request module on” or “Request module off.” Since the same specified sequence is performed over different times, plural initiation times are specified in the respective event data items 1001.

FIG. 3B shows a first example of time adjustment processing to be performed on the sensor data items 1002 using the event data items 1001 by the sensor data time adjustment block 1023. Shown in the drawing are (a) sensor data items that have not undergone time adjustment, and (b) sensor data items that have undergone time adjustment. As shown in (a), elapsed times from a calculated cutting initiation time to different times within the same specified sequence, at which respective sensor data items are observed, are calculated. As shown in (b), the times of the cut sensor data items are arranged on the same time base with a zero time fixed. A time interval between adjoining ones of the elapsed times from the initiation time may not be set to a certain time interval. Otherwise, the time interval may be set to the certain time interval that is the shortest time interval. In the table (b), numerals listed in the table of sensor data items having undergone time adjustment indicate acquired sensor data items, and a blank implies that the sensor data concerned cannot be acquired.

FIG. 3C shows a second example of time adjustment processing to be performed on sensor data items using event data items 1001 by the sensor data time adjustment block 1023. In this example, as shown in the drawing, a time interval Δt′_{correct} of a corrected sensor data stream is modified using a time interval Δt_{ref} of a reference sensor data stream according to formula 1 below so that the cutting initiation time t_{s,correct} and cutting termination time t_{e,correct} of the corrected sensor data stream shown in (b) can be squared with the cutting initiation time t_{s,ref} and cutting termination time t_{e,ref} of the reference sensor data stream shown in (a).

$$\begin{matrix}[ Math . 1 ] & \\ Δ {t}_{correct}^{′} = \frac{{t}_{e , correct} - {t}_{s , correct}}{{t}_{e , ref} - {t}_{s , ref}} \times Δ {t}_{ref} & ( 1 )\end{matrix}$$

Thus, a corrected sensor data stream (c) having undergone time adjustment ensues.

[Determination of Sensor Data Estimation Times]

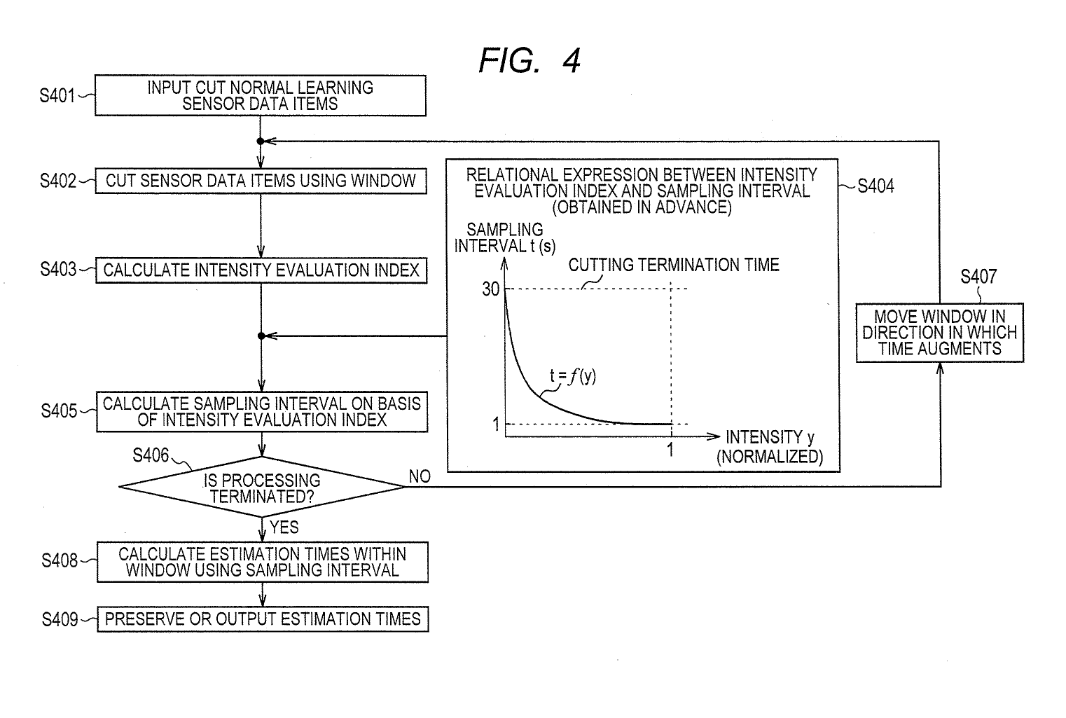

Referring to FIG. 4, a flow of sensor data estimation time determination processing to be performed by the estimation time determination unit (112) will be described below. A sensor data stream having undergone time adjustment and being obtained by processing normal sensor data items for learning, which are read from the database 111, in the data preprocessing unit 102 is inputted to the sensor data estimation time determination unit 112 (S401). A window is used to cut partial sensor data items (S402), and an intensity evaluation index is calculated (S403). A relational expression between the intensity evaluation index and a sampling interval is used to calculate the sampling interval on the basis of the intensity evaluation index (S405). Whether the processing is terminated is decided (S406). If a No decision is made, the window is moved in a direction in which the time augments (S407). The processing of calculating the sampling interval by calculating the intensity of sensor data items (S402 to S405) is repeated. If a Yes decision is made, the sampling interval is used to calculate estimation times within the window (S408). The estimation times are preserved or outputted (S409).

In the present invention, an intensity evaluation index of time-sequential data items is defined to be quantized depending on whether a frequency of a time-sequential wave is high or low, or a magnitude of a rise or fall of the time-sequential wave. In other words, if the frequency of the time-sequential wave is high or the magnitude of the rise or fall of the time-sequential wave is large, intensity is large. In contrast, if the frequency of the time-sequential wave is low or the magnitude of the rise or fall of the time-sequential wave is small, the intensity is small.

More particularly, for example, Fourier analysis is performed on partial data items, which are cut with a window, in order to calculate a power spectrum. A frequency relevant to a maximum value of the power spectrum is regarded as the frequency of the data stream. A frequency of the data stream normalized with a certain maximum frequency is regarded as an intensity I_{freq} in terms of a frequency. A maximum value of a difference between adjoining ones of the data items is normalized with a difference of certain maximum data, and the resultant value is regarded as an intensity I_{|Δy|} in terms of a difference of data. As for the difference of a certain frequency or certain data, for example, a maximum value statistically calculated using all sensor data items may be utilized. However, the present invention is not limited to the maximum value. The intensity of the data stream is calculated according to a formula below.

[Math. 2]

I=max(I_{freq}(freq),I_{|Δy|}(|Δy|)) (2)

As for the intensity evaluation index, any other definition may be adopted.

The relational expression between the intensity evaluation index and sampling interval is obtained separately by conducting in advance experiments or simulation (S404). As shown in the drawing, a maximum value of the sampling interval is a sampling interval for data acquisition, and a minimum value is one second. The intensity evaluation index and sampling interval have an inversely proportional relationship.

As for the determination of sensor data estimation times, the sensor data estimation time may be determined at intervals of a predetermined certain time. Alternatively, the estimation time may be determined at regular intervals so that a specified number of sensor data items can be estimated.

As mentioned above, by determining sensor data estimation times, a processing cost can be reduced and processing can be highly efficiently carried out.

[Estimation of Sensor Data Items]

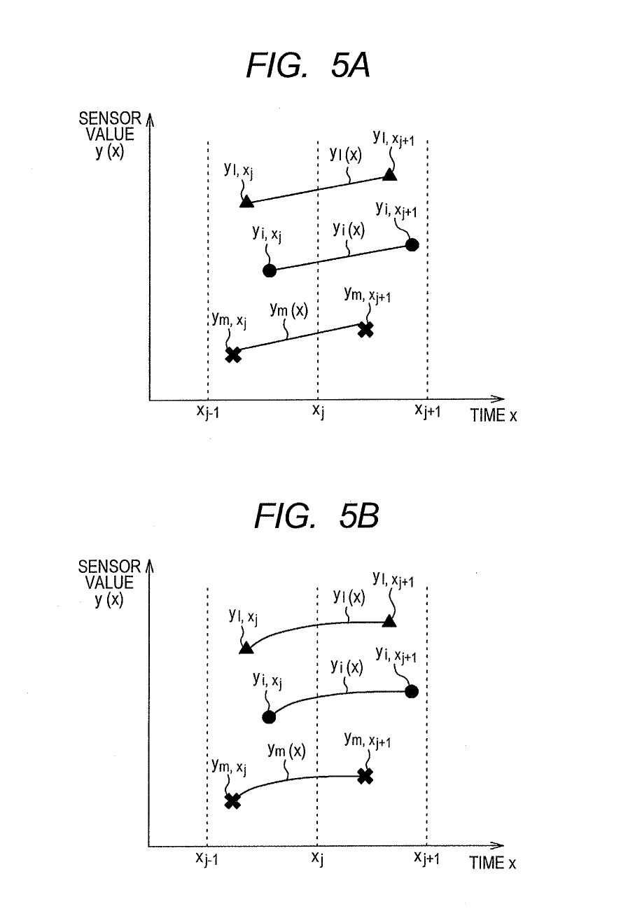

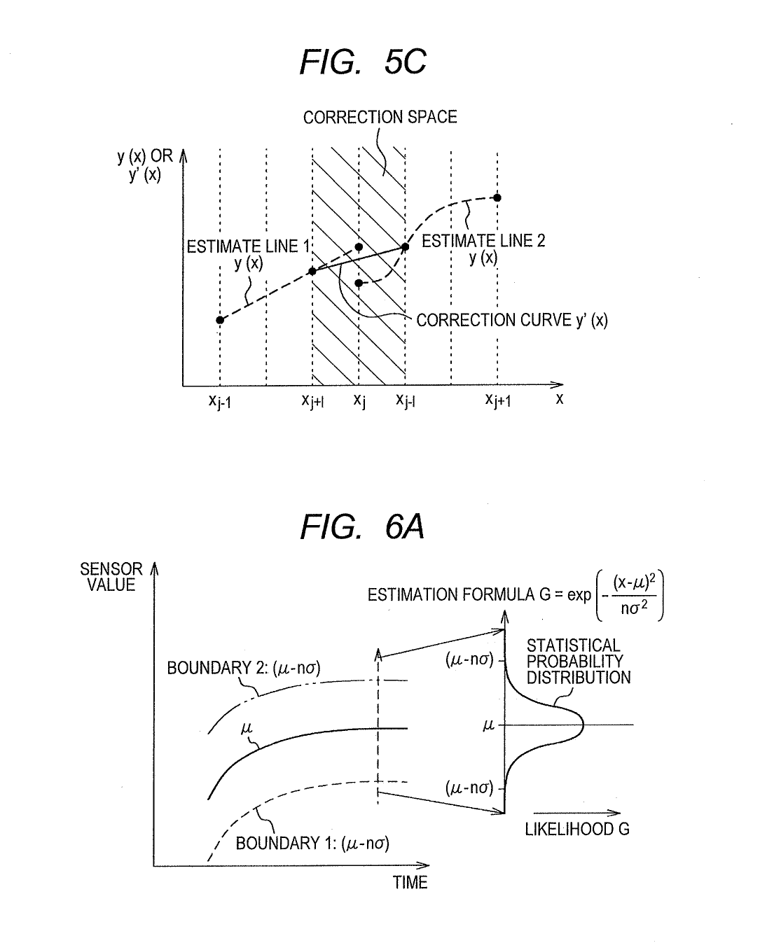

Referring to FIG. 5A, FIG. 5B, and FIG. 5C, estimation of sensor data items (calculation of estimate sensor data items) to be performed by the sensor data estimation unit will be described below. The estimate sensor data can be calculated by performing weighted addition on acquired sensor data of an acquired sensor data stream and other sensor data items of the same acquired sensor data stream which are acquired at different times close to the time of the estimate sensor data within the same specified sequence.

FIG. 5A shows a first example of sensor data estimation. In the first example, a sensor data estimate between acquired sensor data items is linearly calculated based on the acquired sensor data items on both sides of the sensor data estimate. Assuming that y(x) denotes an estimate of data which cannot be acquired, yₓ denotes an acquired sensor data value, j denotes a sampling number (j ranges from 1 to n) obtained by counting up time-adjusted data items in units of a sampling interval from 0 second to an acquisition time of data concerned, and i denotes a number (i ranges from 1 to m) assigned to the same specified sequence within which data items are acquired at different times,

$$\begin{matrix}[ Math . 3 ] & \\ y ( x ) = d \times ( ( \frac{x - {x}_{j}}{{x}_{j + 1} - {x}_{j}} ) \cdot {y}_{{x}_{j - 1}} + ( \frac{{x}_{j + 1} - x}{{x}_{j + 1} - {x}_{j}} ) \cdot {y}_{{x}_{j}} ) + ( 1 - d ) \times ( {\sum }_{i = 1}^{m} {β}_{1 i} {y}_{i , {x}_{j}} + {\sum }_{i = 1}^{m} {β}_{2 i} {y}_{i , {x}_{j - 1}} ) {x}_{j} \leq x \leq {x}_{j + 1} & ( 3 )\end{matrix}$$

y(x) is calculated according to formula (3).

In a second example shown in FIG. 5B, estimate sensor data is nonlinearly calculated using all acquired sensor data items included in the same acquired sensor data stream as the data stream to which the estimate sensor data belongs. An estimate y(x) of sensor data is expressed as follows:

$$\begin{matrix}[ Math . 4 ] & \\ y ( x ) = d \times {\sum }_{j = 1}^{n} {α}_{j} {y}_{x} + ( 1 - d ) \times ( {\sum }_{i = 1}^{m} {β}_{1 i} {y}_{i , {x}_{j}} + {\sum }_{i = 1}^{m} {β}_{2 i} {y}_{i , {x}_{j + 1}} ) & ( 4 )\end{matrix}$$

where α denotes a weight coefficient, and a is obtained using x, which has undergone higher-order mapping, according to a formula below.

$$\begin{matrix}[ Math . 5 ] & \\ α = ( k ( x , {x}_{1} ) , Λ , k ( x , {x}_{N} ) ) {( \begin{matrix}k ( {x}_{1} , {x}_{1} ) & Λ .. & k ( {x}_{N} , {x}_{1} ) \\ \dot{{M}_{.}} & {\dot{M}}_{.} & {\dot{M}}_{.} \\ k ( {x}_{1} , {x}_{N} ) & Λ .. & k ( {x}_{N} , {x}_{N} )\end{matrix} )}^{- 1} & ( 5 )\end{matrix}$$

A higher-order mapping function employed is expressed as follows:

$$\begin{matrix}[ Math . 6 ] & \\ k ( x , {x}^{′} ) = exp ( - λ {‖ x - {x}^{′} ‖}^{2} ) & ( 6 )\end{matrix}$$

where λ denotes an experimentally determined coefficient.

Further, β₁ᵢ, and β₂ᵢ denote weight coefficients that are calculated based on a variance among peripheral acquired sensor data items.

For estimation of sensor data, a spline method and bi-cubic method are available. Any of some techniques may be adopted or the techniques may be switched for use. For switching, for example, an intensity index is employed.

If different techniques are employed in estimating sensor data items within a section partitioned with acquired sensor data items, a displacement of data like a vertical step takes place at a point where the techniques are switched.

FIG. 5C shows an example of correcting a step at a sampling point. In this example, an estimate line 1 and estimate line 2 have a step at a point xⱼ. A correction space 21 sampling interval for data acquisition) is defined across the sampling point xⱼ, and two sensor data items are linearly linked with a correction curve y′(x) within the correction space ranging from a point xⱼ₋₁ to a point xⱼ₊₁. Specifically, a vertical step occurring on a border (seam) between two estimated sensor data items is changed to an oblique step in order to change a discontinuous linkage like the vertical step into a smooth linkage.

As mentioned above, corrected sensor data y′(x) within the correction space is obtained according to a formula below.

[Math. 7]

y′(x)=(1−w(x))y(xⱼ−1)+w(x)y(xⱼ+1)((xⱼ−1)≦x≦(xⱼ+1)) (7)

A weight coefficient w(x) is calculated as follows:

$$\begin{matrix}[ Math . 8 ] & \\ w ( x ) = \frac{x - ( {x}_{j} - l )}{2 l} & ( 8 )\end{matrix}$$

As mentioned above, by performing sensor data estimation, data items that cannot be acquired due to a restriction imposed on equipment can be estimated. In particular, a severe change in a sequence preventing acquisition of data items can be reproduced.

[Estimation of Statistical Probability Distributions]

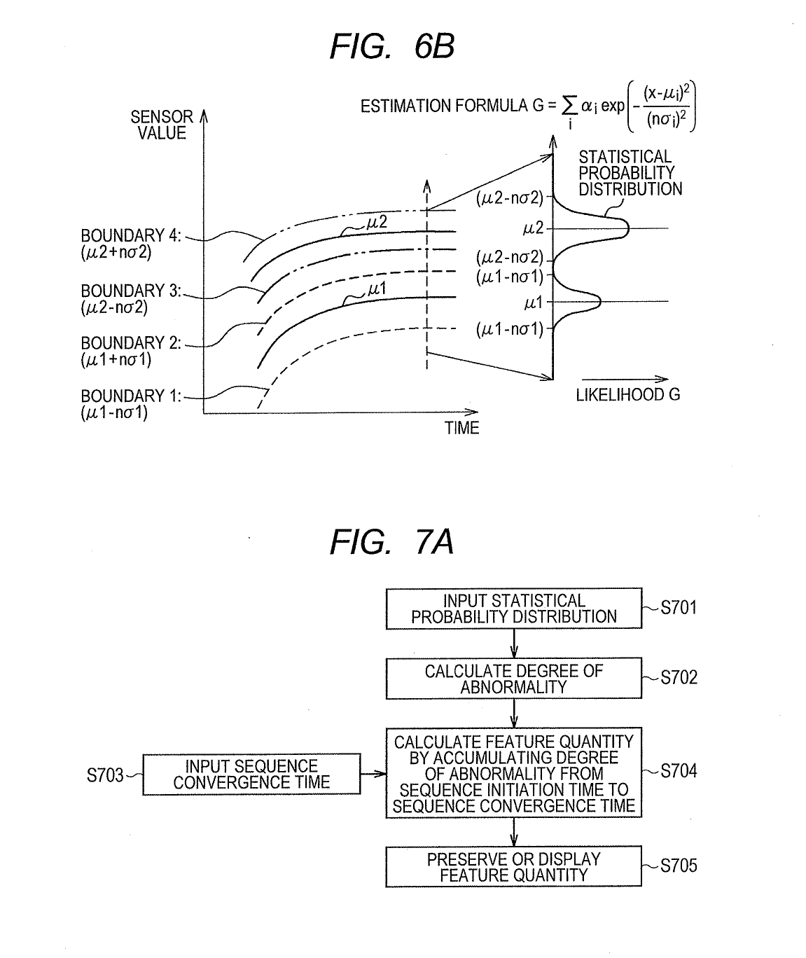

Estimation of statistical probability distributions to be performed by the statistical probability distribution estimation unit 104, that is, a method of estimating probability distributions at respective estimation times using estimated values of sensor data items supposed to be acquired at different times within each of the same specified sequences will be described below in conjunction with FIG. 6A and FIG. 6B.

An example shown in FIG. 6A is a probability distribution G in a case where sensor data at each of estimation times follows a normal distribution. In this case, the probability distribution G is expressed with a Gaussian function defined below using a mean value μ of sensor data at the estimation time and a standard deviation thereof.

$$\begin{matrix}[ Math . 9 ] & \\ G ( x ; μ , σ ) = exp ( - \frac{{( x - μ )}^{2}}{n {σ}^{2}} ) & ( 9 )\end{matrix}$$

In contrast, an example shown in FIG. 6B is an example of a probability distribution G in a case where sensor data at each of estimation times does not follow a normal distribution. In this case, for example, the distribution may be approximated using a multivariate Gaussian function. Any other function may be used for the approximation. When the distribution is approximated using the multivariate Gaussian function, the resultant distribution is expressed as follows:

$$\begin{matrix}[ Math . 10 ] & \\ {G}_{muld} = {\sum }_{i} {α}_{i} {G}_{i} & ( 10 )\end{matrix}$$

The aforesaid estimation of a statistical probability distribution G makes it possible to grasp a distributing situation of sensor data at each time. In addition, as for sensor data newly observed at each time, what is a ratio of normality to abnormality can be discerned.

[Extraction of a Feature Quantity]

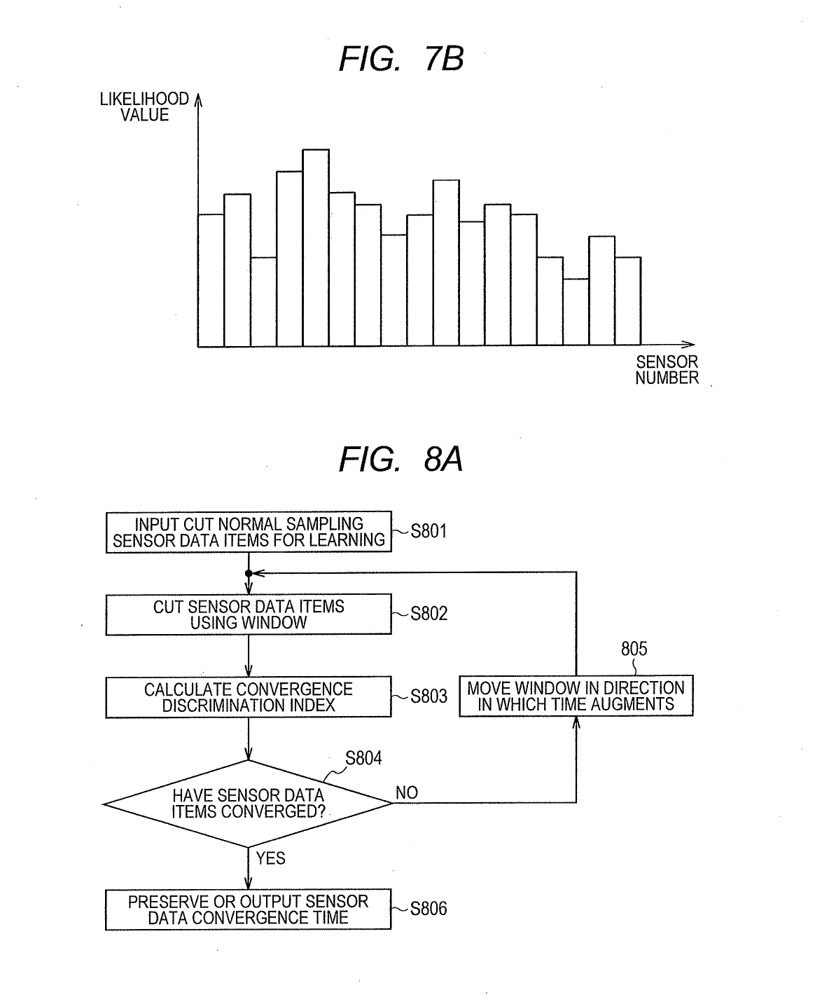

A flow of feature quantity extraction processing to be performed by the feature quantity extraction unit 105 will be described below in conjunction with FIG. 7A. First, statistical probability distributions G at respective estimation times fed from the statistical probability distribution estimation unit 104 are inputted (S701).

Thereafter, a degree of abnormality v(t) is calculated using the statistical probability distribution G at each estimation time according to formula 10 below (S702).

[Math. 11]

v(t)=1−G(x;μ,σ) (11)

A sequence convergence time obtained through discrimination of convergence of a sensor wave to be performed by the feature quantity extraction unit 105 as described later is inputted (S703). A likelihood that is a feature quantity is calculated by accumulating the degree of abnormality v from a sensor data cutting initiation time to the sequence convergence time by using formula 12 (S704).

$$\begin{matrix}[ Math . 12 ] & \\ f = {\sum }_{t = {t}_{s}}^{{t}_{e}} v ( t ) & ( 12 )\end{matrix}$$

The processing from S701 to S703 is performed with respect to all sensors. Finally, likelihoods concerning all the sensors are integrated in order to obtain a likelihood histogram expressed by formula 13 below. Subscripts S₁ to Sₙ denote sensor numbers.

$$\begin{matrix}[ Math . 13 ] & \\ ℏ = ( {f}_{{s}_{1}} \cdot Λ \cdot {f}_{{s}_{n}} ) & ( 13 )\end{matrix}$$

FIG. 7B shows a likelihood histogram into which extracted feature quantities are integrated.

The sequence convergence time inputted at S703 mentioned in FIG. 7A is obtained by discriminating convergence of a sensor wave using a predetermined number of cut sensor data items, which is a default number of sensor data items, in a case where a user instruction is used to select at the time of cutting sensor data items that automatic calculation is not performed.

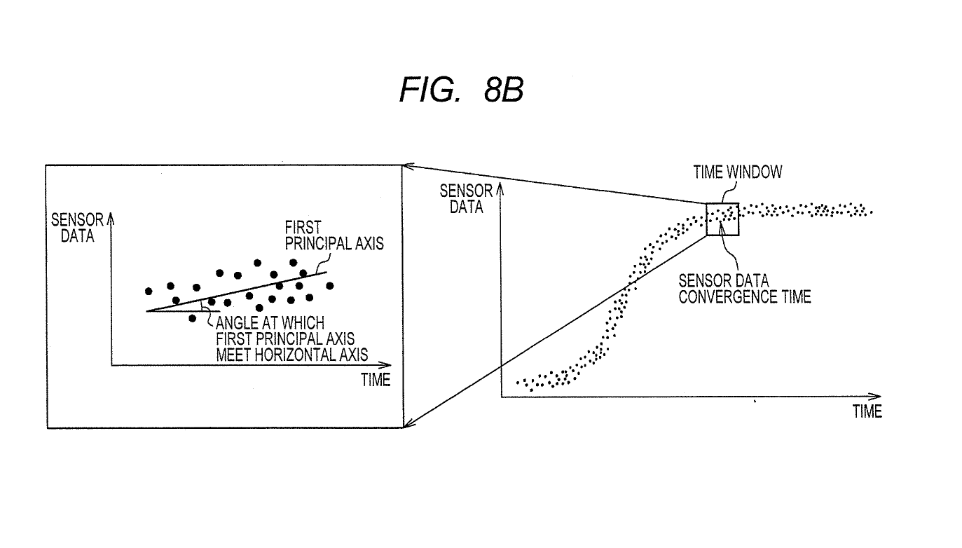

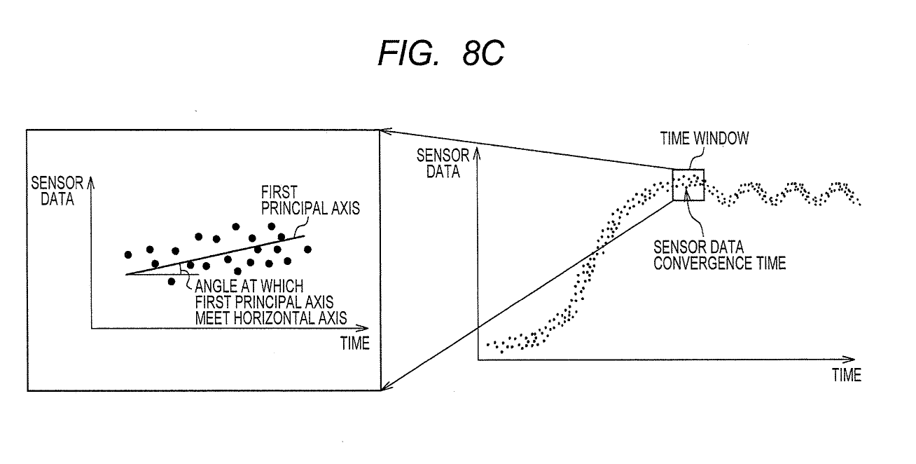

FIG. 8A describes a flow of processing of obtaining a convergence time. First, cut normal sampling sensor data items are inputted (S801). Thereafter, partial sensor data items are cut using a window (S802), a convergence discrimination index is calculated (S803), and convergence discrimination is performed (S804). If a No decision is made, the window is moved in a direction in which the time augments (S805). Convergence discrimination (S802 to S804) is repeated. If a Yes decision is made, a sensor data convergence time is outputted (S806).

What is referred to as a sequence convergence time is a time at which after a sequence is begun, sensor data items observed within the sequence begin to converge on a certain value, or a time when the sensor data items begin oscillating with a certain value around a constant value. FIG. 8B shows an image indicating a convergence discrimination index employed in the former case, and FIG. 8C shows an image indicating the convergence discrimination index in the latter case.

FIG. 8B shows the convergence discrimination index in the case where sensor data items converge on a certain value. The convergence discrimination index is a slope of a first principal axis resulting from principal component analysis that involves sampling sensor data items that are cut with a window, or a regression line resulting from linear regression. The sensor data items are observed to fall within a range from a predetermined maximum value to a predetermined minimum value of final partial sampling data items, and a restrictive condition that a difference between the maximum value and minimum value should be equal to or smaller than a predetermined threshold is additionally included. Among some times at which the convergence discrimination index gets smaller than the predetermined threshold, the first time is regarded as the sequence convergence time.

FIG. 8C shows a convergence discrimination index in a case where sensor data items oscillate with a certain value around a constant value. The convergence discrimination index in this case is also the slope of a first principal axis resulting from principal component analysis that involves sampling sensor data items cut with a window (an angle at which the first principal axis meets a horizontal axis as shown in FIG. 8C). After a cosine wave is fitted to a peak of final partial sampling data items, a similarity is calculated. A restrictive condition that the similarity should be equal to or larger than a predetermined threshold is additionally included. Among some times at which the convergence discrimination index gets smaller than the predetermined threshold, the first time is regarded as the sequence convergence time.

[GUI]

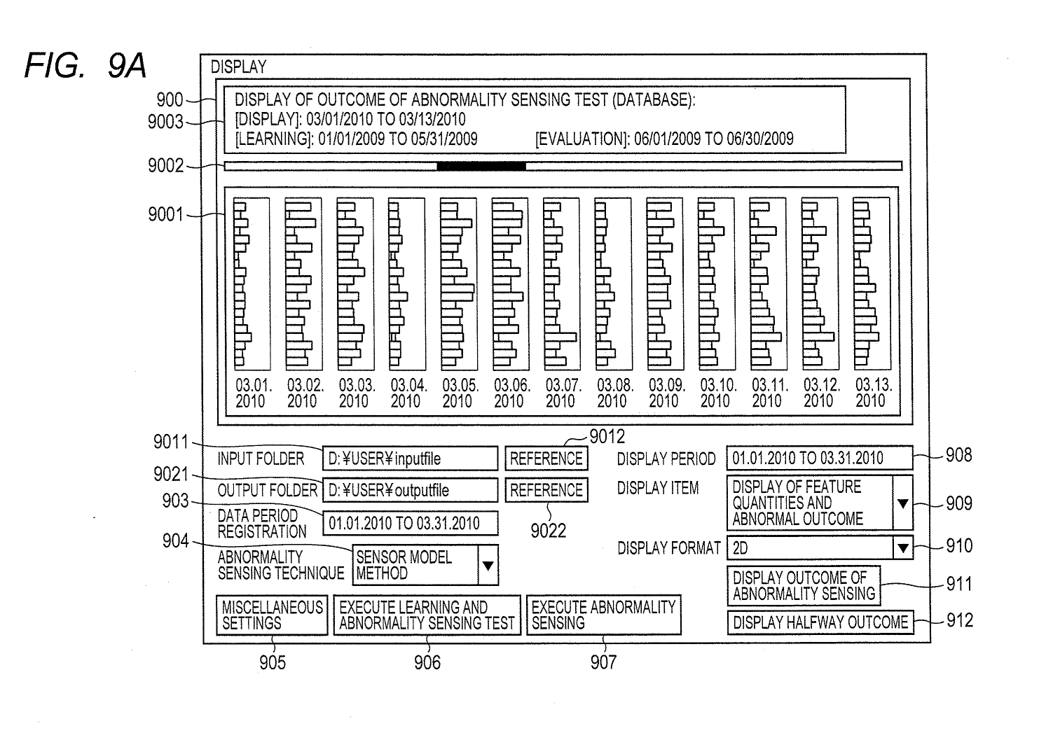

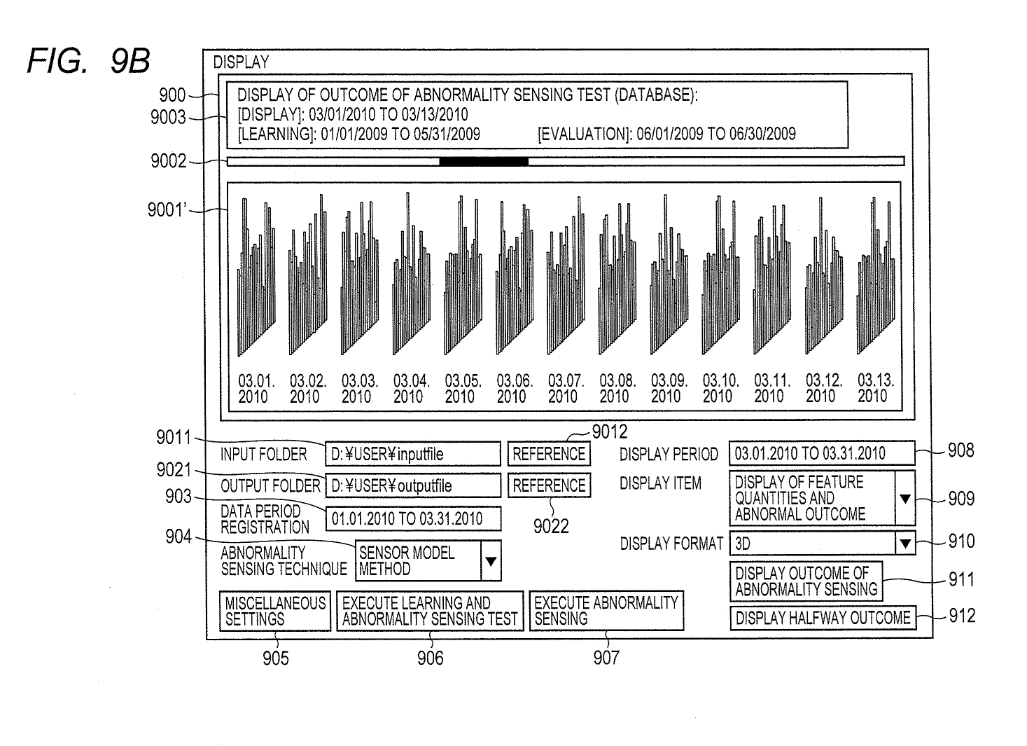

Next, a GUI to be employed in performing pieces of processing will be described in conjunction with FIG. 9A to FIG. 11B.

FIG. 9A and FIG. 9B show a GUI relating to the processing step S101 (S121) of inputting event data items and a user instruction in the flowcharts of FIG. 1B to FIG. 1D, the processing step S104 (S124) of inputting learning sensor data items, the processing step S112 of inputting a normality/abnormality instruction in FIG. 1C, the processing step S111 (S111′) of outputting a normal space or a normality/abnormality decision boundary which is an output processing step mentioned in FIG. 1B or FIG. 1C, the processing step S138 of outputting estimation times in the flowchart of FIG. 1E, the processing steps S211 and S218 of outputting cutting initiation and termination times in the flowchart of FIG. 2B, the processing step S409 of outputting estimation times in the flowchart of FIG. 4, the processing step S705 of outputting a feature quantity in the flowchart of FIG. 7A, the processing step S806 of outputting a sensor data convergence time in the flowchart of FIG. 8A, and the processing step S131 of outputting an outcome of abnormality sensing in the flowchart of FIG. 1D, and a GUI relating to display of an outcome of an abnormality sensing test or an outcome of abnormality sensing.

The GUI includes: a panel 900 on which feature quantities are displayed; a Reference button 9012 for use in selecting a folder that contains a set of files in which sensor data items, indices indicating whether the sensor data items are normal or abnormal, event data items, and parameters are preserved; an Input Folder box 9011 in which the selected folder is indicated; a Reference button 9022 to be depressed in order to select a folder that contains a set of files preserving a normal space (normality/abnormality decision boundary) received at the processing step S111 (S111′), determined estimation times received at the processing steps S138 and S409, cutting initiation and termination times received at the processing steps S211 and S218, a likelihood histogram into which feature quantities received at the processing step S705 are integrated, a sensor wave convergence time received at the processing step S806, and followings which are not shown in the drawing, estimated sensor data items received at the processing step S107 (S127), a halfway outcome such as extracted statistical probability distributions received at the processing step S108 (S128), and an outcome of abnormality sensing received at the processing step S131; an Output Folder box 9021 in which the selected folder is indicated; a Data Period Registration box 903 for use in registering data relevant to learning and an abnormality sensing test that are conducted currently; an Abnormality Sensing Technique selection box 904 for use in selecting a sensing technique; a Miscellaneous Settings button 905 to be depressed in order to designate details of abnormality sensing; an Execute Learning and Abnormality Sensing Test button 906 to be depressed in order to execute learning and an abnormality sensing test using data items read from the database 111; an Execute Abnormality Sensing button 907 to be depressed in order to perform abnormality sensing on data items fed from the facility 111; a Display Period box 908 in which a display period of an outcome of abnormality sensing is indicated; a Display Item box 909 for use in selecting display items such as display of feature quantities and an abnormal outcome; a Display Format box 910 for use in selecting two-dimensional display or three-dimensional display; a Display Outcome of Abnormality Sensing button 911 to be depressed in order to perform abnormality sensing on the basis of the display-related settings and display an outcome of abnormality sensing received at the estimation processing step S107 (S127); and a Display Halfway Outcome button 912 to be depressed in order to receive and display estimated sensor data items and statistical probability distributions which are included in a halfway outcome received at the statistical probability distribution step S108 (S128).

The Input Folder box 9011 and Output Folder box 9021 are used to select folders, the Data Period Registration box 903 is used to register a data period, the Abnormality Sensing Technique selection box 904 is used to select an abnormality sensing technique, and Miscellaneous Settings button 905 is used to enter miscellaneous settings. After these boxes and button are operated, the Execute Learning and Abnormality Sensing Text button 906 is depressed to execute learning processing described in FIG. 1B or FIG. 1C, and execute abnormality sensing test processing, which follows a flow of abnormality sensing described in FIG. 1D, using data items read from the database 111. Once the button 906 is depressed, the Execute Abnormality Sensing button 907, Display Outcome of Abnormality Sensing button 911, and Display Halfway Outcome button 912 cannot be depressed until the abnormality sensing test processing is completed.

After the learning processing and abnormality sensing test processing are completed, a state in which the Execute Abnormality Sensing button 907 can be depressed ensues. In this state, the Display Outcome of Abnormality Sensing button 911 and Display Halfway Outcome button 912 can also be depressed. In this case, when a display period of learning data or abnormality sensing test data is registered in the Display Period box 908, and the Display Item box 909 and the Display Format box 910 are selected, by depressing the Display Outcome of Abnormality Sensing button 911 or Display Halfway Outcome button 912, the halfway outcome or the outcome of abnormality sensing that is available during the display period is displayed on the Display panel 900.

Thereafter, the Execute Abnormality Sensing button 907 is depressed. Accordingly, data items available during a period registered in the Data Period Registration box 903 are read from a storage medium for temporary data storage that is connected to the facility 101 but is not shown. When execution of abnormality sensing is completed, a display period of abnormality sensing data is registered in the Display Period box 908. After the display items are specified in the Display Item box 909 and the display format is specified in the Display format box 910, and the Display Outcome of Abnormality Sensing button 911 or Display Halfway Outcome button 912 is depressed, a halfway outcome of abnormality sensing data available during the display period or an outcome of abnormality sensing is displayed on the Display panel 900.

Before a display-related button is depressed, a progress of execution is displayed on the Display panel 900. For example, first, “Please designate settings.” is displayed. Once designation is begun, the message is immediately switched to “Designation is in progress.” After designation of the input folder and output folder, registration of a data period, and designation of an abnormality sensing technique are completed, when the Execute Learning and Abnormality Sensing Test button 906 is depressed, “Learning and an abnormality sensing test are in progress.” appears.

After execution of learning and an abnormality sensing test is completed, “Execution of learning and an abnormality sensing test has been completed. Depress the Execute Abnormality Sensing button 907 so as to perform abnormality sensing. Otherwise, designate the display-related settings, and depress the display button for display.” appears. If the Execute Abnormality Sensing button 907 is not depressed but designation of any of the display-related settings for Display Period, Display Item, and Display Format is begun, the message is switched to “Designation of the display-related setting is in progress.” When designation of the display-related setting is completed, “Designation of the display-related setting has been completed. Depress the display button for display.” appears.

When the Display Outcome of Abnormality Sensing button 911 or Display Halfway Outcome button 912 is depressed, an outcome of learning and an abnormality sensing test is displayed according to settings. In contrast, when the Execute Abnormality Sensing button 907 is depressed, “Execution of an abnormality sensing test is in progress.” appears. When execution of an abnormality sensing test is completed, “Execution of an abnormality sensing test has been completed. Designate the display-related settings.” appears. Once designation of any of the display-related settings is begun, the message is switched to “Designation of the display-related setting is in progress.” When designation of the display-related setting is completed, “Designation of the display-related setting has been completed. Depress the display button for display.” appears. When the Display Outcome of Abnormality Sensing button 911 or Display Halfway Outcome button 912 is depressed, an outcome of abnormality sensing is displayed according to settings.

FIG. 9A shows an example of a GUI display in accordance with the present example of the invention. In this example, feature quantities 9001, an abnormality bar 9002, and display-related items 9003 concerning display are displayed on the display panel 900. The display-related items 9003 include a kind of display data (an outcome of an abnormality sensing test using data items read from the database or an outcome of abnormality sensing using data items fed from the facility), a display period, and a learning period and evaluation period required to obtain this outcome. The abnormality bar 9002 indicates in black the positions of feature quantities in which an abnormality is found.

The example shown in FIG. 9A is an example in which an outcome of an abnormality sensing test using data items read from the database 111 is shown. An outcome of abnormality sensing using data items fed from the facility 101 can also be displayed, but not shown in the drawing. If 3D is specified in the Display Format, three-dimensional feature quantities 9001′ like those shown in FIG. 9B are displayed on the Display panel 900.

By displaying the GUI like the one shown in FIG. 9A or FIG. 9B, a likelihood histogram into which feature quantities are integrated or an outcome of abnormality sensing can be discerned and therefore can be easily understood by a user.

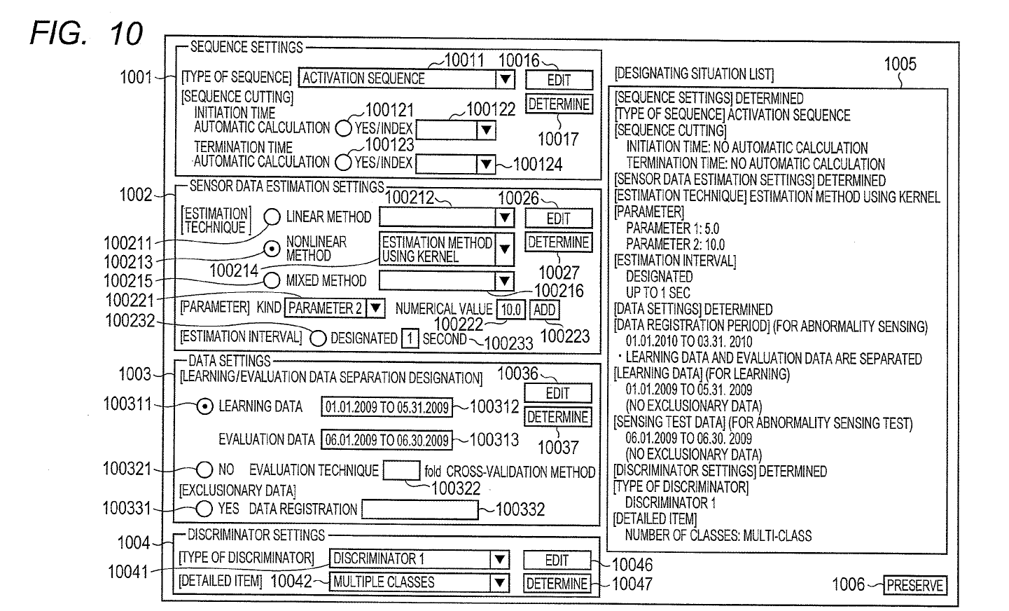

FIG. 10 shows a GUI to be used to designate the details of abnormality sensing and to be called by depressing the Miscellaneous Settings button 905 shown in FIG. 9. The GUI is concerned with settings needed for the processing step S105 (S125) of calculating sensor data cutting initiation and termination times and cutting sensor data items and the sensor data estimation step S107 (S127) which are described in FIG. 1B to FIG. 1D.

The GUI includes a Sequence Settings field 1001, a Sensor Data Estimation Settings field 1002, a Data Settings field 1003, a Discriminator Settings field 1004, a Designating Situation List display panel 1005, and a Preserve button 1006.

In the Sequence Settings field 1001, when an Edit button 10016 is depressed, all items can be edited. Editing items include Type of Sequence and Sequence Cutting. The Type of Sequence includes a box 10011 for use in selecting a type of sequence. The Sequence Cutting includes check boxes 100121 and 100123 which are used to indicate Yes for the items of sequence cutting initiation time automatic calculation and sequence cutting termination time automatic calculation, and boxes 100122 and 100124 which succeed the respective Yes boxes and are used to select an index to be employed in automatic calculation. The Type of Sequence selection box 1011 can be used to select a type of sequence such as activation or suspension for which an abnormality should be sensed. In the Sequence Cutting, whether the initiation and termination times are automatically calculated can be determined.

When automatic calculation is performed, the Yes check boxes 100121 and 100123 are ticked. In the index boxes 100122 and 100124, indices to be employed are specified. In case automatic calculation is not to be performed, the Yes check boxes are not ticked, and the use index selection boxes are left blank. In this case, default sequence cutting initiation and termination times are employed.

The example shown in FIG. 10 is an example in which an activation sequence is entered in the box 10011 for use in selecting a type of sequence. In this example, automatic calculation of the sequence cutting initiation and termination times is not performed. Therefore, the Yes boxes are not ticked, and the index selection boxes are left blank. By depressing a Determine button 10017, the contents of designation made in the Sequence Settings field 1001 are registered.

In the Sensor Data Estimation Settings field 1002, when an Edit button 10026 is depressed, all items can be edited. Editing items includes Estimation Technique, Parameter, and Estimation Interval. The Estimation Technique includes check boxes 100211, 100213, and 100215 for use in selecting a linear method, nonlinear method, and mixed method respectively, and boxes 100212, 100214, and 100216 for use in selecting detailed methods associated with the respective classification methods.

For selecting the estimation technique, any of the check boxes 100211, 100213, and 100215 for use in selecting the linear method, nonlinear method, and mixed method respectively of the Estimation Technique is ticked. The succeeding boxes 100212, 100214, or 100216 for use in selecting the associated technique is used to determine the estimation technique. The Parameter includes a selection box 100221 for use in selecting a kind of parameter, a box 100222 for use in entering concrete numerals of the selected parameter, and an Add button 100223 to be depressed in order to select another kind of parameter and enter other numerals after completion of selecting one kind of parameter and entering numerals.

The Estimation Interval includes a check box 10232 to be ticked when an estimation interval is Designated, and a box 100233 in which the estimation interval is entered when the Designated box is ticked. In case the estimation interval is not to be designated, the Designated check box is not ticked and the number of seconds is not entered in a succeeding space. In this case, normal learning data items are automatically used to determine estimation times according to the intensity of each sensor wave. In case the estimation interval is to be designated, the Designated check box is ticked, and the number of seconds is entered in the succeeding space. Accordingly, the estimation time is designated at intervals of the designated number of seconds.

In the example shown in FIG. 10, the check box 100213 for the nonlinear method is ticked, and an estimation method employing the kernel is specified in the associated technique selection box 100214. Parameter 1 or parameter 2 is selected using the Kind selection box 100221 in the Parameter, and numerical values of 10.0 is entered into the numerical value box 100222. The estimation interval is designated at 100232 and set to 1 second at 100233. By depressing the Determine button 10027, the contents of designation made in the Sensor Data Estimation Settings field 1002 are registered.

In the Data Settings field 1003, when an Edit button 10036 is depressed, all items can be edited. Editing items include Learning/evaluation Data Separation Designation and Exclusionary Data. Further, the Learning/evaluation Data Separation Designation includes a Yes check box 100311, a box 100312 in which a learning data period is entered when Yes is selected for designation, a box 100313 in which an evaluation data period is entered, a No check box 100321 to be ticked when No is selected for designation, and a box 100322 in which the number of folds employed in an evaluation technique for automatically separating learning data and evaluation data from each other is entered. The Exclusionary Data includes a Yes check box 100331, and a Data Registration box 100332 in which data is registered when Yes is selected.

In the example shown in FIG. 10, the Yes check box 100311 in the learning/evaluation data separation designation is ticked, and designation periods are entered in the learning data box 100312 and evaluation data box 100313 respectively. Since exclusionary data is not found, the Yes check box 100331 in the Exclusionary Data is not ticked. The Data Registration box 100332 is left blank. By depressing the Determine button 10037, the contents of designation made in the Data Settings field 1003 are registered.

In the Discriminator Settings field 1004, when an Edit button 10046 is depressed, all items can be edited. Editing items include Type of Discriminator and Detailed Item. A Type of Discriminator box 10041 and Detailed Item box 10042 are associated with the respective editing items. The Type of Discriminator box 10041 enables selection of a type of discriminator. For example, a support vector machine, Bayes discriminator, k-nearest neighbor discriminator, neural network, and others are available. In the Detailed Item box 10042, a detailed item associated with a discriminator selected using the Type of Discriminator box 10041 can be selected. For example, as for the number of classes to be handled by the discriminator, a single class or multiple classes can be selected. If the single class is selected, learning is performed according to the processing flow for learning described in FIG. 1B in order to obtain a normal space. If the multiple classes is selected, learning is performed according to the processing flow for learning described in FIG. 1C in order to obtain a normality/abnormality decision boundary. In the present example of the invention, the discriminator 1 is specified in the Type of Discriminator box 10041, and the multiple classes is specified in the Detailed Item box 10042. By depressing the Determine button 10047, the contents of designation made in the Discriminator Settings field 1004 are registered.

At the time when the entered contents are inputted, the contents are automatically displayed in the Designating Situation List 1005. In a case where each of setting items is edited, “Being edited.” is displayed subsequently to the item name. When determination is made, if the Determine button 10016, 10026, 10036, or 10046 is depressed, “Being edited.” succeeding each item name is changed to “Determined.” If any item should be corrected, the Edit button in the field in which the setting item to be corrected is present is depressed for editing. After editing is completed, if the Determine button 10017, 10027, 10037, or 10047 in the field concerned is depressed, correction is completed.

After the contents of display in the Designating Situation List 1005 are verified, and the Preserve button 1006 is depressed, the contents of designation shown in FIG. 10 are preserved, and the GUI shown in FIG. 10 disappears.

After the GUI shown in FIG. 10 is used to designate details of sensor data estimation, the Execute Learning and Abnormality Sensing Text button 906 shown in FIG. 9A or FIG. 9B is depressed in order to perform learning and an abnormality sensing test. Thereafter, the Execute Abnormality Sensing button 907 is depressed in order to perform abnormality sensing. As for a normal space or decision boundary to be employed in abnormality sensing, the one obtained during learning is utilized.

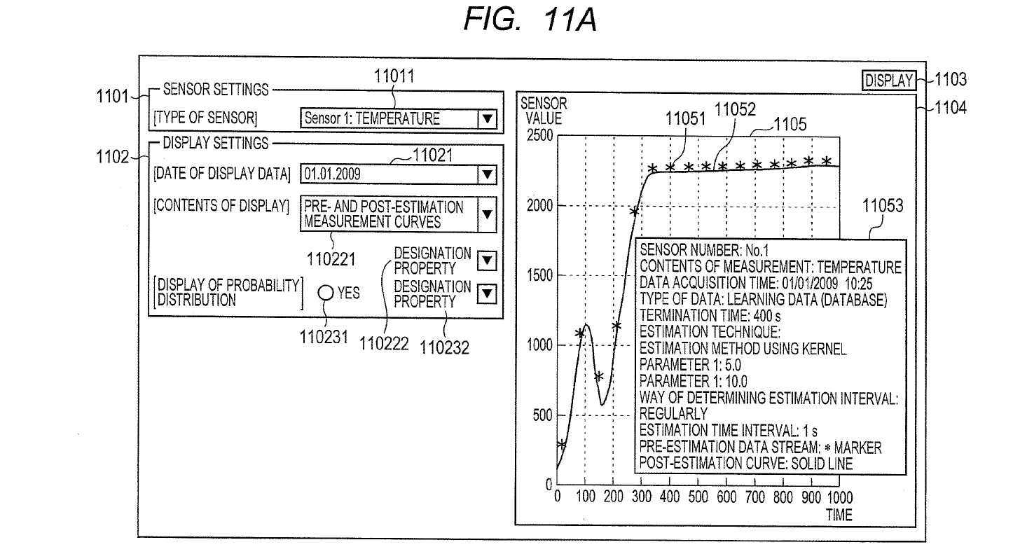

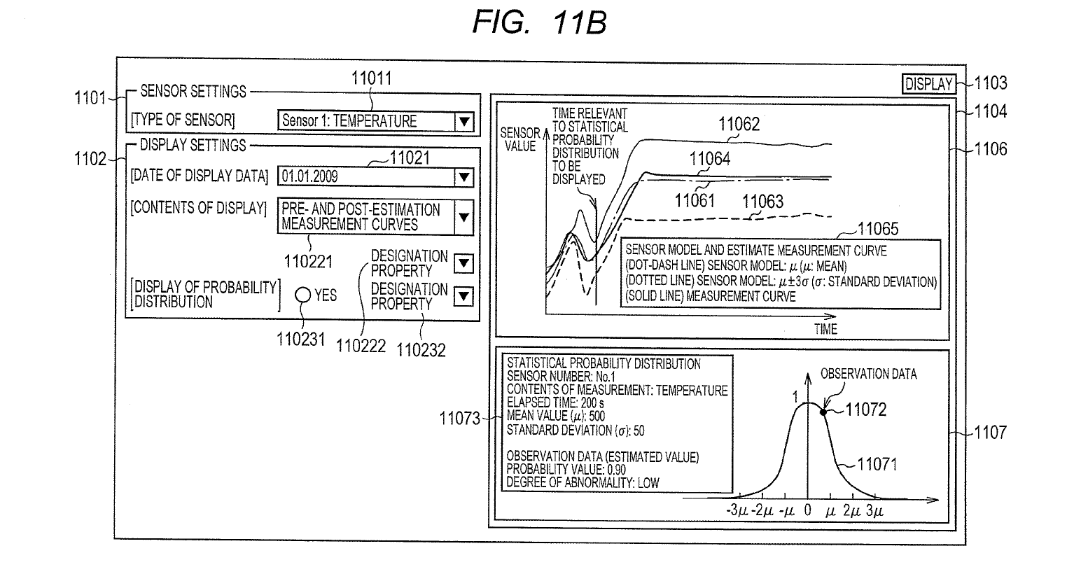

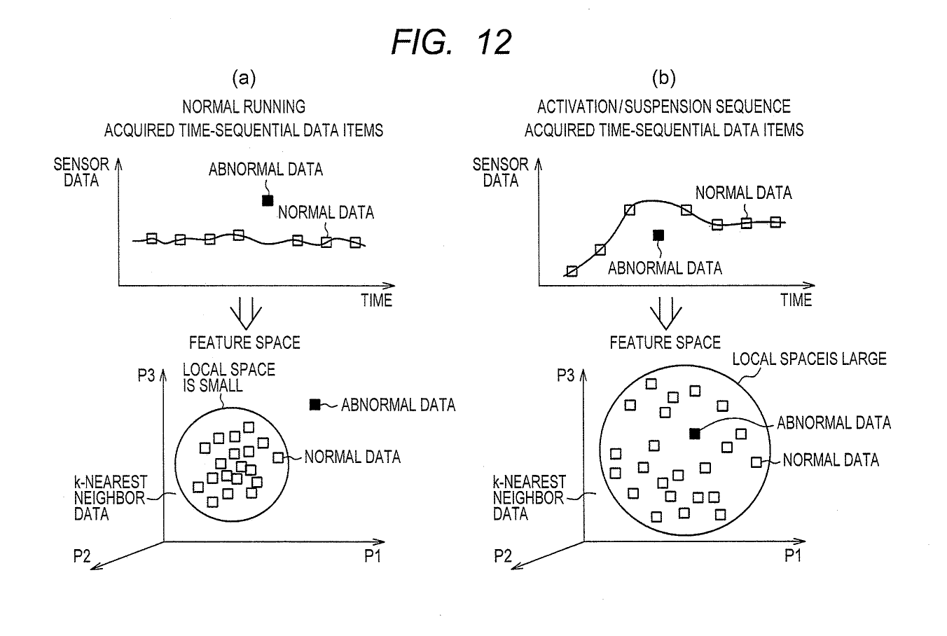

A GUI concerned with checking of an estimated measurement curve that is a halfway outcome, a sensor model, and a statistical probability distribution at a certain time in the sensor model, which are obtained after performing learning, an abnormality sensing test, and abnormality sensing, will be described below in conjunction with FIG. 11A and FIG. 11B.

A GUI shown in FIG. 11A and FIG. 11B includes a Sensor Settings field 1101, a Display Settings field 1102, a Display button 1103 to be depressed in order to execute display, and a Display Panel field 1104. The Sensor Settings 1101 includes a Type of Sensor item. A type of sensor is selected using a selection box 11011. The Display Settings 1102 includes Date of Display data, Contents of Display, and Probability Distribution Display.

A date of display data is entered in a Date of Display Data box 11021. The contents of display are selected using a Contents of Display selection box 110221. Designation Property 110222 below the selection box is used to select the property of the contents of display. The Probability Distribution Display includes a check box 110231 to be ticked in the case of Yes. In the case of Yes, Designation Property 110232 for designation can be used.

FIG. 11A shows an example in which pre- and post-estimation measurement curves are displayed. In the example shown in FIG. 11A, Pre- and Post-Estimation Measurement Curves is specified in the Contents of Display selection box 110221, and appropriate options are specified in the other items. In this state, when the Display button 1103 is depressed, a graph 1105 presenting the relationship between times and sensor values is displayed in the Display Panel field 1104. A pre-estimation data stream 11051 is discrete, while a post-estimation sensor wave 11052 is continual.

Setting items relating to the graph are displayed in a field 11053. Display items encompass items designated through the GUI mentioned in conjunction with FIG. 10, and include a sensor number of a multidimensional sensor, the contents of measurement, a data acquisition time, kind of data (learning data or evaluation data, data read from the database or data fed from the facility, or the like), a convergence time, a sensor data estimation technique, values of parameters employed in estimation, a way of determining an estimation time interval, an estimation time interval, a kind of marker indicating the pre-estimation data stream, and a kind of curve representing the post-estimation sensor wave. As for the display in the field 11053, the right button of a mouse may be clicked in order to select an option in which the field 11053 is not displayed.

In FIG. 11A, Sensor Model and Post-estimation Measurement Curve is specified in the Contents of Display selection box 110221, and appropriate options are specified in the other items. In this state, when the Display button 1103 is depressed, a graph 1106 presenting estimate measurement curves for respective sensor models is displayed in a field 1104 as shown in FIG. 11B. In the graph 1106, a dot-dash line 11061 indicates a mean value curve (μ) of a sensor model, and thin line 11062 and dotted line 11063 indicate curves representing values obtained by adding or subtracting a triple of a standard deviation to or from the mean value curve of the sensor model (μ3σ). A solid line 11064 indicates a post-estimation measurement curve. Setting items relating to the graph are displayed in a field 11065. Display items signify what curves the respective lines indicate. As for the display of the field 11065, the right button of a mouse may be clicked in order to select an option in which the field is not displayed.

Further, a time relevant to a statistical probability distribution that is requested to be seen is selected using a mouse (a position indicated with an arrow in the graph 1106), and the right button of the mouse is clicked in order to select display of the distribution. Then, the statistical probability distribution 1107 observed at the specified time is, as shown in FIG. 11B, displayed below the graph 1106 within the field 1104. The statistical probability distribution 1107 at the certain time includes a Gaussian curve 11071 and observation data 11072, and has items relevant to the statistical probability distribution displayed in a field 11073. Display items in the field 11073 include a sensor number, the contents of measurement, an elapsed time by the time at which the statistical probability distribution is observed, a numerical value of a mean value, a numerical value of a standard deviation, and a probability value and degree of abnormality in the statistical probability distribution of an estimated value of the observation data. As for the display of the field 11073, the right button of the mouse may be clicked in order to select an option that the field is not displayed.

Owing to the GUI described in conjunction with FIG. 11A and FIG. 11B, selection of a sensor data estimation technique, designation of parameters, or the like can be achieved easily. In addition, since outcomes obtained before and after sensor data estimation can be verified, the validity of the selected technique or designated parameters can be confirmed. Further, a probability distribution and a location or degree of abnormality of newly observed data can be discerned, and a progress of a sequence can be checked.

The invention devised by the present inventor has been concretely described based on the example. Needless to say, the present invention is not limited to the example, but may be modified in various manners without a departure from the gist of the invention.

### REFERENCE SIGNS LIST

101 . . . facility,
100 . . . abnormality sensing path,
100′ . . . learning path,
100″ . . . estimation time determination path,
1001 . . . event data,
1002 . . . sensor data,
1003 . . . user instruction,
1004 . . . decision boundary or normal space,
102 . . . data preprocessing unit,
1021 . . . event data analysis block,
1022 . . . sensor data cutting block,
1023 . . . sensor data time adjustment block,
103 . . . sensor data estimation unit,
104 . . . statistical probability distribution estimation unit,
105 . . . feature quantity extraction unit,
106 . . . abnormality sensing unit,
111 . . . database,
112 . . . estimation time determination unit,
113 . . . learning unit.

1. A facility status monitoring method for sensing an abnormality of a plant or facility, comprising the steps of:
inputting a sensor signal that is intermittently outputted from a sensor attached to a plant or facility, and event signals associated with initiation and termination respectively of an activation sequence or suspension sequence of the plant or facility during the same period as the period during which the sensor signal is outputted;
cutting a sensor signal, which is associated with a section between the event signal of the initiation of the activation sequence or suspension sequence and the event signal of the termination of the activation sequence or suspension sequence, from the inputted sensor signal;
estimating signal values at certain times of the cut sensor signal, and probability distributions of the respective signal values;
extracting a feature quantity on the basis of the estimated probability distributions; and
sensing an abnormality of the plant or facility on the basis of the extracted feature quantity.

2. The facility status monitoring method according to claim 1,
wherein estimating signal values at certain times of the cut sensor signal and probability distributions of the respective signal values is performed by: synchronizing the cut sensor signal with times that are obtained with the event signal of the initiation of the activation sequence or suspension sequence as an origin; determining times at which data items of the synchronized sensor signal are estimated; estimating sensor data items to be observed at the determined times; and estimating probability distributions of the estimated sensor data items.

3. The facility status monitoring method according to claim 2,
wherein the technique for estimating sensor data items is selected from among a plurality of techniques displayed on a screen, and the sensor data items are estimated based on the selected technique.

4. The facility status monitoring method according to claim 2,
wherein information on the estimated sensor data items is displayed on the screen.

5. The facility status monitoring method according to claim 1,
wherein sensing an abnormality of the plant or facility on the basis of the extracted feature quantity is achieved by using a sensor signal, which is obtained when the plant or facility operates normally, to determine a normal space or decision boundary for the sensor signal, deciding whether the extracted feature quantity falls within or inside the determined normal space or decision boundary, and sensing the abnormality of the plant or facility.

6. A facility status monitoring device for sensing an abnormality of a plant or facility, comprising:
a data preprocessing unit that inputs a sensor signal, which is intermittently outputted from a sensor attached to a plant or facility, and event signals associated with initiation and termination respectively of an activation sequence or suspension sequence of the plant or facility, cutting a sensor signal, which is associated with a section between the event signal of the initiation of the activation sequence or suspension sequence and the event signal of the termination of the activation sequence or suspension sequence, from the inputted sensor signal, and synchronizing the cut sensor signal with times that are obtained with the event signal of the initiation of the activation sequence or termination sequence as an origin;
a probability distribution estimation unit that estimates signal values at certain times of the sensor signal, which is processed by the data preprocessing unit, and probability distributions of the respective signal values;
a feature quantity extraction unit that extracts a feature quantity on the basis of the probability distributions estimated by the probability distribution estimation unit;
an abnormality detector that detects an abnormality of the plant or facility on the basis of the feature quantity extracted by the feature quantity extraction unit; and
an input/output unit that includes a screen on which information to be inputted or outputted is displayed, and displays on the screen information concerning the abnormality of the plant or facility detected by the abnormality detector.

7. The facility status monitoring device according to claim 6,
wherein the probability distribution estimation unit includes:
an estimation time determination block that determines times at which data items of the cut sensor signal, which is synchronized with the times that are obtained with the event signal of the initiation of the activation sequence or suspension sequence as an origin, are estimated;
a sensor data estimation block that estimates sensor data items to be observed at the times determined by the estimation time determination block; and
a statistical probability distribution estimation block that estimates statistical probability distributions of the sensor data items estimated by the sensor data estimation block.

8. The facility status monitoring device according to claim 7,
wherein the input/output unit displays on the screen a plurality of techniques according to which the sensor data estimation block estimates sensor data items, and the sensor data estimation block estimates the sensor data items according to the technique selected on the screen from among the plurality of displayed techniques.

9. The facility status monitoring device according to claim 7,
wherein the input/output unit displays on the screen information concerning the sensor data items estimated by the sensor data estimation block.

10. The facility status monitoring device according to claim 6,
wherein the abnormality detector includes a learning unit that uses a sensor signal, which is obtained when the plant or facility operates normally, to determine a normal space or decision boundary for the sensor signal, and an abnormality sensing unit that decides whether the feature quantity extracted by the feature quantity extraction unit falls within or inside the determined normal space or decision boundary, and senses an abnormality of the plant or facility.
